(19) United States
(12) Patent Application Publication
(10) Pub. No.: US 2026/0250480 A1
(43) Pub. Date: Aug. 27, 2026

(54) PROCESS OF PREPARING HIGH-PURITY POLYPROPYLENE RECYCLATES

(71) Applicants: BOREALIS GMBH, Vienna (AT); IFP ENERGIES NOUVELLES, Rueil-Malmaison (FR)

(72) Inventors: Andreas ALBRECHT, Linz (AT); Joel FAWAZ, Linz (AT); Alexandra Romina ALBUNIA, Linz (AT); Yi LIU, Linz (AT); Noureddine AJELLAL, Kulloo (FI); Mohammad AL-HAJ ALI, Kulloo (FI); Lukas SOBCZAK, Linz (AT); Henry SLEIJSTER, Sittard-Geleen (NL); Pablo Ivan AGUAYO ARELLANO, Linz (AT); Mubashar SATTAR, Kullo (FI); Wilfried WEISS, Rueil-Malmaison (FR); Damien LEINEKUGEL LE COCQ, Rueil-Malmaison (FR); Mathilde SIBEAUD, Rueil-Malmaison (FR)

(73) Assignees: BOREALIS GMBH, Vienna (AT); IFP ENERGIES NOUVELLES, Rueil-Malmaison (FR)

(21) Appl. No.: 19/162,752

(22) PCT Filed: Mar. 8, 2024
(86) PCT No.: PCT/EP2024/056218

§ 371 Date: Sep. 5, 2025

(30) Foreign Application Priority Data
Mar. 8, 2023 (EP) 23305308.1

(51) Int. Cl. C08J 11/08; B29B 17/00; B29B 17/02; B29K 23/00

(52) U.S. Cl. CPC C08J 11/08; B29B 17/02; B29B 2017/0015; B29B 2017/0224; B29B 2017/0293; B29K 2023/12; C08J 2323/12

(57) ABSTRACT

The present disclosure provides a process of preparing a polymer composition comprising a post-consumer recycled polypropylene resin comprising the steps of M) pre-treating a plastic feedstock by subjecting the plastic feedstock to mechanical recycling process; S) subjecting the plastic feedstock to solvent-based recycling process to obtain the post-consumer recycled polypropylene resin; and C) melt-processing the post-consumer recycled polypropylene resin obtained from step S) to obtain said polymer composition, wherein the conditions of the steps M), S) and C) are particularly selected and combined for the preparation of high-purity polypropylene recyclates.

The present disclosure is directed to a process of preparing a polymer composition comprising a post-consumer recycled polypropylene resin.

### BACKGROUND OF THE INVENTION

The challenge of disposal of accumulated plastic waste and corresponding environmental issues have received widespread attention from the public and professionals. Therefore, recycling of plastic material has become an important topic, where plastic waste can be turned into resources for new plastic products. Hence, environmental and economic aspects can be combined in recycling and reusing plastic material.

Although recycling of plastic material has already begun in the mid-90s by implementing collection systems, which allow more target orientated collection and separation of plastic materials from other household waste materials, the reuse of plastic material originating from plastic waste is still limited. The so-called post-consumer recycled (PCR) plastic material generally contains mixtures of different plastics and a wide range of contaminants. Methods have been developed to further purify the post-consumer recycled (PCR) plastic material.

Post-consumer recyclates obtained by mechanical recycling facilities, comprising sorting according to color and chemical structure followed by an intensive washing process, have still several disadvantages as the purification is limited to the surface of the polymer particles, and any of the substances in the bulk of the particles cannot be removed. Extrusion and degassing/aeration can be used to partly remove higher size fillers, e.g., via melt filtration, and reduce volatiles, respectively. Mechanical recycling processes are generally known and described, e.g., in WO2022/200588 and WO2022/200587.

Nevertheless, even with the current advanced mechanical recycling technology, properties like the amount of filler content, the presence of specific metals, color, volatiles, and odor can hinder applications that require higher-purity polymer materials. Solvent-based recycling provides post-consumer recycled polymers with higher purity grades. For example, WO2017/003798A1 discloses a process of dissolving post-consumer use polymers, wherein polymers with relatively low contaminant contents are prepared. Further solvent-based recycling processes are disclosed in WO2022/128490A1 and WO2022/128488A1. However, these contaminant contents may still not allow for employment of the recycled polymers in all applications, and processes for improved removal of contaminants are still required.

The demand for high-quality recyclates is very strong and is increasing due to the voluntary sustainability targets set by many companies. In addition, there is an upcoming regulation setting a certain percentage target of recyclates for incorporation into the final product.

Thus, there is a need for processes providing high-purity post-consumer recyclates that may be used in a variety of applications.

### SUMMARY OF THE INVENTION

An object of the present invention is to provide a process of preparing a polymer composition comprising a post-consumer recycled polypropylene resin that addresses the above-described needs.

Accordingly, the present invention provides a process of preparing a polymer composition, particularly a melt-processed polymer composition, comprising a post-consumer recycled polypropylene resin comprising the steps of
M) pre-treating a plastic feedstock by subjecting the plastic feedstock to mechanical recycling process, preferably accomplished by sieving, sorting by at least one of polymer type, polymer article form and/or color, shredding, and optionally cleaning, e.g. washing, the plastic feedstock to obtain a pre-treated plastic feedstock;
S) subjecting the pre-treated plastic feedstock to solvent-based recycling process to obtain the post-consumer recycled polypropylene resin accomplished by dissolving a plastic feedstock comprising polypropylene in a solvent and separating non-dissolved components and soluble impurities, wherein step S) comprises
S-a) a dissolution step in which the pre-treated plastic feedstock is placed in contact with a dissolution solvent at a dissolution temperature of between 100° C. and 300° C. and a dissolution pressure of between 1.0 and 20.0 MPa abs, to obtain at least one, preferably one, crude polymer solution, wherein the dissolution solvent is chosen from organic solvents comprising one or more hydrocarbons with a boiling point of between 75° C. and 250° C., to obtain at least one crude polymer solution;
S-b) optionally a step of adsorption by placing the crude polymer solution obtained from step S-a) in contact with at least one adsorbent, at a temperature of between 10° and 300° C. and a pressure of between 1.0 and 20.0 MPa abs, to obtain at least one refined polymer solution; and
S-c) a step of recovering polymers (from the at least one crude polymer solution of step S-a) or from the at least one refined polymer solution) to obtain at least one solvent fraction and one purified polymer fraction; and
C) melt-processing the post-consumer recycled polypropylene resin obtained from step S), wherein step C) comprises
C-a) further separating solvent from the purified polymer fraction, and
C-b) melt-processing the purified polymer fraction
to obtain said polymer composition.

It has been found that by dissolving a (mechanically) pre-treated plastic feedstock in a dissolution solvent chosen from organic solvents comprising one or more hydrocarbons with a boiling point of between 75° C. and 250° C. to recover a purified polymer fraction and thereafter melt-processing the purified polymer fraction with further separation of solvent from the purified polymer fraction, removal of impurities such as limonene and hexanal (which can create odor problems) are improved.

### SHORT DESCRIPTION OF THE FIGURES

FIG. 1 shows the relationship between the ethylene content (C2) of polypropylene resins and the ethylene content of the crystalline fraction of the respective resins (C2(CF)) for the examples IE1 and IE2, in comparison to a variety of virgin PP resins.

### DETAILED DESCRIPTION OF THE INVENTION

For the purposes of the present description and of the subsequent claims, the term “post-consumer waste” refers to objects having completed at least a first use cycle (or life cycle), i.e., having already served their first purpose. The term “virgin” denotes the newly produced materials and/or objects prior to their first use, which have not already been recycled. The term “recycled” such as used herein denotes materials reprocessed from “recycled waste”.

The present invention provides a process of preparing a polymer composition comprising a post-consumer recycled polypropylene resin.

### Process of Preparing the Polymer Composition

### Plastic Feedstock

The post-consumer recycled polypropylene resin as described herein may be obtained from plastic feedstock, comprising, preferably consisting of, plastic waste, such as post-consumer waste, comprising at least polypropylene.

The plastic feedstock may comprise mixtures of polymers comprising at least polypropylene, in particular mixtures of polyolefins, and more particular mixtures of polypropylene and other polyolefins and/or other polymers, such as polyethylene (PE), polystyrene (PS), polyamide (PA), polyvinyl chloride (PVC), expanded polystyrene (EPS), and/or polyethylene terephthalate (PET), additives used to formulate the plastic material(s), as well as use-related impurities originating from the life cycle of the materials and plastic objects and/or originating from the waste collection and sorting circuit, these compounds being collectively considered as impurities. The plastic feedstock may further comprise other contaminations such as paper, cardboard, wood, textile, metal(s), glass, sand, etc. originating from the other constituents of the original plastic objects.

The said plastic feedstock may thus comprise impurities. Said plastic feedstock may comprise up to 50 wt % of impurities, preferably up to 20 wt % of impurities, more preferably up to 15 wt %, such as 1 to 10 wt %, of impurities of the total weight of the plastic feedstock. One particular example of the impurities comprised in the plastic feedstock are additives. The additives used in plastics are organic or inorganic compounds, such as fillers, colorants, pigments, plasticizers, property modifiers, combustion retardants, etc.

In particular the plastic feedstock comprises polyolefins, including polypropylene (PP), polyethylene (PE), and their copolymers, in particular mixtures of polyolefins. In accordance with the present disclosure the plastic feedstock typically comprises at least 60 wt %, preferably at least 80 wt %, more preferably at least 85 wt % by weight, such as 80 to 90 wt %, of polyolefins, of the total weight of the plastic feedstock. The plastic feedstock preferably comprises at least 60 wt %, more preferably at least 80 wt %, most preferably at least 85 wt %, such as 80 to 90 wt %, of polypropylene, of the total weight of the plastic feedstock.

### Recycling Process

The desired post-consumer recycled (PCR) polypropylene resin of the polymer composition is prepared from a plastic feedstock as discussed herein by a recycling process comprising combination of mechanical recycling process step(s) and solvent-based recycling (SbR) process step(s)

Accordingly, the present invention relates to a process of providing a polymer composition comprising a post-consumer recycled polypropylene resin as defined herein in terms of its properties, wherein the post-consumer recycled polypropylene resin and, thus, also the polymer composition is obtained from a plastic feedstock, the process comprising the steps of
M) pre-treating a plastic feedstock by subjecting the plastic feedstock to mechanical recycling process, comprising sieving, sorting by at least one of polymer type, polymer article form, and/or color, shredding, and optionally cleaning, e.g. washing, the plastic feedstock to obtain pre-treated plastic feedstock, and optionally melting the pre-treated plastic feedstock;
S) subjecting the pre-treated, optionally molten, plastic feedstock to solvent-based recycling process to obtain the post-consumer recycled polypropylene resin, preferably accomplished by dissolving a plastic feedstock comprising polypropylene in a solvent and separating non-dissolved components and soluble impurities, wherein step S) comprises
S-a) a dissolution step in which the pre-treated plastic feedstock is placed in contact with a dissolution solvent at a dissolution temperature of between 100° C. and 300° C. and a dissolution pressure of between 1.0 and 20.0 MPa abs, to obtain at least one, preferably one, crude polymer solution, wherein the dissolution solvent is chosen from organic solvents comprising one or more hydrocarbons with a boiling point of between 75° C. and 250° C. to obtain at least one crude polymer solution;
S-b) optionally a step of adsorption by placing the crude polymer solution obtained from step S-a) in contact with at least one adsorbent, at a temperature of between 10° and 300° C. and a pressure of between 1.0 and 20.0 MPa abs, to obtain at least one refined polymer solution; and
S-c) a step of recovering polymers (from the at least one crude polymer solution of step S-a) or from the at least one refined polymer solution) to obtain at least one solvent fraction and one purified polymer fraction; and
C) melt-processing the post-consumer recycled polypropylene resin obtained from step S), wherein step C) comprises
C-a) further separating solvent from the purified polymer fraction, and
C-b) melt-processing the purified polymer fraction
to obtain said polymer composition.

Throughout this disclosure, pressures are indicated as absolute pressures (abs).

Advantageously the process comprises the steps of:
M-a) providing a plastic feedstock, comprising, preferably consisting of, plastic waste, such as post-consumer waste, comprising at least polypropylene;
M-b) sieving the plastic feedstock to create sieved plastic waste material comprising at least polypropylene having only articles with a longest dimension in a defined range, such as from 30 to 400 mm;
M-c) sorting the sieved plastic waste material by means of one or more sorting systems, wherein the sieved waste polymer material is at least sorted by polymer type, polymer article form, and/or by color, thereby generating sorted polypropylene recycling material that is subjected to steps M-d) and beyond;
M-d) shredding the sorted polypropylene recycling material to form a flaked polypropylene recycling stream, whereby the flakes preferably have a longest dimension from 2.5 to 20 mm to obtain a pre-treated plastic feedstock;
S-a) a dissolution step involving placing the pre-treated plastic feedstock in contact with a solvent to obtain at least one crude polymer solution; and then
S-E1) optionally a step of separating out the insoluble matter to obtain at least one clarified polymer solution and one insoluble fraction;
S-b) a step of adsorption of the impurities by contact with an adsorbent solid to obtain at least one refined polymer solution;
S-c) a step of recovering polymers, to obtain at least one solvent fraction and one purified polymer fraction;
C-a) further separating solvent from the purified polymer fraction, and
C-b) melt-processing, preferably melt-extruding and/or pelletizing, the purified polymer fraction, preferably wherein additives are added in the melt state, to obtain a melt-processed, preferably melt-extruded and/or pelletized, polymer composition comprising the post-consumer polypropylene recycled resin.

### Mechanical Recycling Pre-Treatment M)

The plastic feedstock comprising at least polypropylene is first pre-treated by a mechanical recycling process, the said mechanical recycling process preferably comprising the steps of:
M-a) providing a plastic feedstock, comprising, preferably consisting of, plastic waste, such as post-consumer waste, comprising polypropylene;
M-b) sieving the plastic feedstock to create sieved plastic waste material comprising polypropylene having only articles with a longest dimension in a defined range;
M-c) sorting the sieved plastic waste material by means of one or more sorting systems, wherein the sieved waste polymer material is at least sorted by polymer type, polymer article form and/or by color, thereby generating sorted polypropylene recycling material that is subjected to steps M-d) and beyond;
M-d) shredding the sorted polypropylene recycling material to form a flaked polypropylene recycling stream, whereby the flakes preferably have a longest dimension from 2.5 to 20 mm to obtain pre-treated flaked polypropylene recycling material;
M-e) optionally cleaning the pre-treated flaked polypropylene recycling material one or more times with a gaseous and/or aqueous cleaning medium, whereby gravitational principles are applied to separate the flakes from the medium to obtain cleaned pre-treated polypropylene recycling material;
M-f) optionally separating the cleaned pre-treated polypropylene recycling material into a light fraction and a heavy fraction polypropylene recycling material to obtain pre-treated heavy fraction polypropylene recycling material; and
M-g) optionally further sorting the pre-treated heavy fraction polypropylene recycling material or, in the case that step M-f) is absent, the cleaned pre-purified polypropylene recycling material by means of one or more optical sorters comprising NIR and/or optical sensors sorting for one or more target polypropylene by removing any flakes containing material other than the one or more target polypropylene(s) and/or of flakes of undesired color (e.g. natural, black etc.), yielding further purified pre-treated polypropylene recycling material;
M-h) optionally melt-extruding, and optionally pelletizing, the pretreated polypropylene material in flake form obtained from the last step executed of steps M-d) to M-g), to obtain melt-extruded, optionally pelletized, pre-treated polypropylene recycling material.

The melt-extruded, optionally pelletized, pre-treated polypropylene recycling material, or in the case that step M-h) is absent, the further purified pre-treated polypropylene recycling material or, in the case that step M-g) and beyond is absent, the pre-purified heavy fraction polypropylene recycling material or, in the case also step M-f) and beyond is absent, the cleaned pre-treated polypropylene recycling material, or in the case that step M-e) and beyond is absent, the pre-treated flaked polypropylene recycling material may then be utilized as the plastic feedstock for the above described solvent-based recycling process.

As discussed above, the pre-treated polypropylene recycling material is preferably fed to the dissolution step S-a) of the solvent-based recycling process as a melt feed whereby the flakes or the melt-extruded form, e.g., pellets, of the pre-treated polypropylene recycling material are molten before being fed to the dissolution step S-a). The temperature of the molten polypropylene feed is preferably at the dissolution temperature in step S-a) or higher. More preferably, the temperature of the molten polypropylene feed is higher than the temperature in step S-a). Melt feeding can be performed in a continuous manner, as the melt feed can be pressurized to match the pressure in the dissolution step. However, also batchwise operation is possible, but less desired.

### Step M-b) of Sieving the Plastic Feedstock

According to the present disclosure, the pre-treatment of the plastic feedstock comprises a step M-b) of sieving the plastic feedstock. The sieving is accomplished to remove oversize and undersize fractions to render a sieved plastic recycling material having only articles with a longest dimension in a defined range, for example up to 400 mm. Preferably the said longest dimension is from 30 to 400 mm, more preferably from 50 to 100 mm.

### Step M-c) of Sorting the Sieved Plastic Waste Material

According to the present disclosure, the pre-treatment of the plastic feedstock comprises a step M-c) of sorting the sieved plastic waste material by means of one or more sorting systems wherein the sieved waste polymer material is sorted by at least one of polymer type, polymer article form, and/or by color, thereby generating a pre-treated polypropylene recycling stream.

The preferred sorting systems include near infrared (NIR) and/or optical sensors wherein is at least sorted by polymer type, polymer article form, and/or by color, thereby generating a sorted polypropylene recycling material that is subjected to steps M-d) and beyond. In step M-c) the sieved plastic waste material is preferably at least sorted by color, and optionally also polyolefin type and/or article form. The sorted polypropylene material is preferably enriched in polypropylene content and may comprise any desired mixture of polypropylene objects, said objects being colored and/or un-colored, flexible and/or rigid.

The term “article form”, as used herein, refers to the shape and form of articles present in the waste polymer material. Such articles may be present, inter alia, in the form of films, bags, and pouches, which may be considered as flexible articles, and, inter alia, in the form of moulded articles such as food containers, skin-care product containers, and plastic bottles, which may be considered as rigid articles. Commercial optical sorters, such as Tomra Autosort, RTT Steinert Unisort, and Redwave Pellenc, are able to separate so-called rigid articles from so-called flexible articles via their aerodynamic properties (i.e. a stream of gas is typically applied to the stream and those articles being rigid articles will fall with a different arc than flexible articles), converting streams containing such articles into so-called rigid streams and flex streams.

In sorting step M-c) preferably non-polypropylene materials including polystyrene, polyamide, polyethylene, metals, paper, and wood are sorted out.

In sorting step M-c) preferably white and natural waste materials are sorted out so that substantially only waste materials of non-white and/or non-natural colors, that are least preferred for direct reuse, remain in the one or more sorted polypropylene recycling stream. In this context “natural” signifies that the objects are of natural color. This means that essentially no pigments (including carbon black) or colorants such as dyes or inks are included in the objects. On the other hand, “white” signifies that white pigments are included in the objects.

### Step M-d) of Shredding the Sorted Polypropylene Recycling Stream

According to the present disclosure, the pre-treatment of the plastic feedstock comprises a step M-d) of shredding the sorted polypropylene recycling material to form a flaked polypropylene recycling stream. Preferably the flakes have a longest dimension from 2.5 to 20 mm, more preferably from 5 to 15 mm.

The generated pre-treated flaked polypropylene recycling material is suitable for the solvent-based recycling process as the pre-treated plastic feedstock or for the steps M-e) and beyond). This sorted polypropylene material comprises any homogeneous mixture of polypropylene articles, colored and un-colored, as well as heterogeneous mixtures of flexible and rigid polypropylene objects.

### Step M-e) of Cleaning the Flaked Polypropylene Recycling Stream

According to the present disclosure, the pre-treatment of the plastic feedstock comprises a step M-e) of cleaning the flaked polypropylene recycling material one or more times with a gaseous and/or aqueous cleaning medium, whereby gravitational principles are applied to separate the flakes from the medium to generate a cleaned polypropylene recycling material to obtain a pre-treated polypropylene recycling stream.

The generated cleaned pre-treated polypropylene recycling material is suitable for the solvent-based recycling process as the pre-treated plastic feedstock or for the steps M-f) and beyond).

The step M-e) preferably comprises:
M-e1) washing the flaked polypropylene recycling material one or more times with an aqueous washing solution, to obtain a suspended polypropylene recycling material and removing the aqueous washing solution and optionally any material not floating on the surface of the aqueous washing solution from the suspended polypropylene recycling material thereby generating a washed polypropylene recycling stream; and
M-e2) drying the washed polypropylene recycling stream, thereby obtaining a dried polypropylene.

### Step M-f) of Separating the Pre-Treated Polypropylene Recycling Stream

According to the present disclosure, the pre-treatment of the plastic feedstock optionally comprises a step M-f) of separating the, optionally cleaned, pre-treated polypropylene recycling material into a light fraction and a heavy fraction polypropylene recycling stream. The separation is preferably done by a windsifter. The separation may alternatively be done based on the aerodynamic properties of the particles (such as flakes, e.g. separating thin light flexible flakes from heavy thick rigid flakes. In sorting step M-f) preferably thin light flexible flakes are sorted out so that substantially only rigid polypropylene objects remain in the sorted polypropylene recycling stream. Preferably the further sorted pre-purified polypropylene recycling material comprises 65 to 100 wt % rigid polypropylenes of the total amount of the pre-purified polypropylene recycling material.

The generated pre-treated heavy fraction polypropylene recycling material is suitable for the solvent-based recycling process as the pre-treated plastic feedstock or for the steps M-g) and beyond. This sorted polypropylene material comprises any mixture of polypropylene articles, colored and un-colored, enriched in rigid polypropylene objects.

### Step M-g) of Further Sorting

According to the present disclosure, the pre-treatment of the plastic feedstock optionally comprises a step M-g) of further sorting the heavy fraction polypropylene recycling material or, in the case that step M-f) is absent, the pre-treated polypropylene recycling material by means of one or more optical sorters with NIR and/or optical sensors sorting for one or more target polypropylene. In sorting step M-g) preferably any flakes containing material other than the one or more target polypropylene(s) and/or of flakes of undesired color (e.g. natural, black etc.) are removed to yield a further purified pre-treated polypropylene recycling stream.

The generated further purified pre-treated polypropylene recycling material is suitable for the solvent-based recycling process as the pre-treated plastic feedstock or for step M-h) and beyond.

### Step M-h) of Melt-Extruding

According to the present disclosure the pre-treatment of the plastic feed stock optionally comprises a step M-h) of melt-extruding the pre-treated polypropylene material in flake form. The melt-extruded plastic feedstock may optionally be pelletized. The step M-h) provides the pre-treated polypropylene material in melt-extruded form, optionally as pellets.

Step M-h) is preferably carried out in an extruder, which can be a single- or a twin screw extruder, which can be fed using one or more loss-in-weight (LIW) feeders, but also using a so-called pre-conditioning unit (PCU), well known to those skilled in the art. Dimensionless throughput Q on this extruder may be calculated with:

$$Q = tr [ kg / s ] / md [ kg / m 3 ] * sd [ m ] * ss [ s - 1 ]$$

where tr is the throughput rate of the extruder, sd is the screw diameter, and ss is the screw speed, is 0.75-0.20, preferably 0.10-0.15.

The target melt temperature is 190-270° C., preferably 200-250° C., and even more preferably 200-230° C.

The pre-treated polypropylene material may optionally be degassed for moisture removal and VOC reduction during extrusion thereof.

Degassing may be via up to three, particularly two, degassing ports, such as one degassing port for top degassing and one degassing port for side degassing, which ports form part of the extruder. The pressure at the degassing ports may be within the range of from 0.5 kPa to 75 kPa abs, preferably from 1 kPa to 50 kPa abs, even more preferably from 1 kPa to 10 kPa abs, achieved with a suitable vacuum system containing one or more vacuum pumps.

The melt-extruded pre-treated polypropylene material may optionally be melt-filtered downstream of the extruder.
Melt filtration may be performed with a continuous melt filtration device, such as so-called laser filters by Erema or an Ettlinger/Maag ERF filter, or a Britas band filter. The filtration level is generally within the range of from 50 to 500 μm, preferably from 50 to 250 μm, even more preferably from 50 to 150 μm.

Optionally, pressure for the melt filtration is provided by one or more gear melt pumps, which, as well known to those skilled in the art, allow efficient pressurizing at low energy input, and thereby reduce melt temperature and the risk of polymer degradation.

The generated melt-treated, preferably melt-extruded and/or optionally pelletized, pre-treated polypropylene recycling material is suitable for the solvent-based recycling process.

The pre-treated polypropylene recycling material may preferably have a polypropylene content above 90%, preferable above 95% based on the total weight of the pre-treated polypropylene recycling material.

The pre-treated polypropylene recycling material may still contain up to 1.5 wt % inorganic contaminants like e.g. talc, chalk, TiO₂ and pigments, up to about 5 wt % polyethylene and small amounts, for example below 0.4 wt %, of other polymers, such as PA, PET, EVA or PVC and odor active substance like limonene, n-hexanal, toluene and other odor active substances.

The pre-treated polypropylene recycling material may be analyzed for its content of polypropylene and contaminates before subjecting the material to the solvent-based recycling process using NIR flake analyzer.

### Solvent-Based Recycling Process S)

The post-consumer recycled polypropylene resin of the present disclosure is obtained by a recycling process comprising after the mechanical recycling process M) as discussed above, a solvent-based recycling process S) for recycling plastic feedstock, comprising plastic waste, such as post-consumer waste, comprising polypropylene, by dissolving the polypropylene in a solvent, under particular temperature and pressure conditions, optionally followed by placing the obtained polymer solution in contact with an adsorbent solid. Generally, the dissolving solvent must be able to solve polyolefins, in particular polypropylene. Therefore, preferably, the dissolving solvent is a non-polar solvent or a mixture thereof. Therefore, the solvent preferably is a hydrocarbon or a mixture of hydrocarbons. More preferably, the dissolving solvent is a paraffinic solvent or a mixture of paraffinic solvents due to paraffinic nature of polyolefins (‘Similia similibus solventum’).

Preferably the solvent-based recycling process S) for purifying a pre-treated plastic feedstock comprises, and preferably consists of:
S-a) a dissolution step, as specified above, involving placing the pre-treated plastic feedstock obtained from mechanical recycling process in contact with a solvent to obtain at least one crude polymer solution; and then
S-E1) optionally a step of separating out the insoluble matter to obtain at least one clarified polymer solution and one insoluble fraction;
S-E2) optionally a washing step, by contact with a dense solution, to obtain at least one washing effluent and one washed polymer solution;
S-E3) optionally an extraction step, by contact with an extraction solvent, to obtain at least one extracted polymer solution and one spent solvent;
S-b) a step of adsorption of the impurities by contact with an adsorbent solid to obtain at least one refined polymer solution; and finally
S-c) a step of recovering polymers (from the at least one refined polymer solution), to obtain at least one solvent fraction and one purified polymer fraction.

As an example, the solvent-based recycling process S) comprises:
S-a) a dissolution step involving placing the plastic feedstock in contact with a dissolution solvent, at a dissolution temperature of between 100° C. and 300° C. and a dissolution pressure of between 1.0 and 20.0 MPa abs, the dissolution solvent being chosen from at least one organic solvent comprising one or more hydrocarbons having a boiling point of between 75° C. and 250° C., to obtain at least one crude polymer solution;
S-b) a step of adsorption by placing the crude polymer solution obtained from step S-a) in contact with at least one adsorbent, at a temperature of between 10° and 300° C. and a pressure of between 1.0 and 20.0 MPa abs, to obtain at least one refined polymer solution; and then
S-c) a step of recovering polymers (from the at least one refined polymer solution), to obtain at least one solvent fraction and one purified polymer fraction.

As a preferred example the solvent-based recycling process step S) comprises, and preferably consists of:
S-a) a dissolution step involving placing the plastic feedstock in contact with a dissolution solvent, at a dissolution temperature of between 100° C. and 300° C. and a dissolution pressure of between 1.0 and 20.0 MPa abs, the dissolution solvent being chosen from at least one organic solvent comprising one or more hydrocarbons having a boiling point of between 75° C. and 250° C., to obtain at least one crude polymer solution;
S-E1) a step of separating out the insoluble matter to obtain at least one clarified polymer solution and one insoluble fraction;
S-E2) optionally a washing step, by contact with a dense solution, to obtain at least one washing effluent and one washed polymer solution;
S-E3) optionally an extraction step, by contact with an extraction solvent, to obtain at least one extracted polymer solution and one spent solvent;
S-b) a step of adsorption by placing the clarified polymer solution obtained from step S-E1), or optionally the washed polymer solution from the step S-E2) or the extracted polymer solution from the step S-E3), in contact with at least one adsorbent, at a temperature of between 10° and 300° C. and a pressure of between 1.0 and 20.0 MPa abs, to obtain at least one refined polymer solution; and then
S-c) a step of recovering polymers (from the at least one refined polymer solution), to obtain at least one solvent fraction and one purified polymer fraction.

### Dissolution Step S-a)

According to the present disclosure, the process comprises a dissolution step S-a) in which the pre-treated plastic feedstock is placed in contact with a dissolution solvent at a dissolution temperature of between 100° C. and 300° C. and a dissolution pressure of between 1.0 and 20.0 MPa abs, to obtain at least one, preferably one, crude polymer solution. Specifically, this step advantageously enables the dissolution of at least a portion and preferably of all of the polymers, preferably polypropylene.

The term “dissolution” should be understood as meaning any phenomenon leading to the production of at least one polymer solution, i.e. a liquid comprising polymers dissolved in a solvent, more particularly in the dissolution solvent. A person skilled in the art is fully aware of the phenomena involved in the dissolution of polymers and which comprises at least mixing, dispersion, homogenization and disentangling of the polymer chains and more particularly of the thermoplastic chains.

In the course of and on conclusion of the dissolution step S-a), the pressure and temperature conditions make it possible to maintain the dissolution solvent, at least a portion and preferably all of the dissolution solvent, in liquid form, whereas the soluble fraction of the feedstock, in particular the targeted polymers, preferably the targeted thermoplastics and preferably the targeted polypropylene, and at least a portion of the impurities, is advantageously at least partly and preferably totally dissolved. The placing in contact between the dissolution solvent and the pre-treated plastic feedstock to at least partly and preferably totally dissolve the polymers of the pre-treated plastic feedstock in the dissolution solvent may be performed in a line and/or an item of equipment and/or between two items of equipment. Thus, step S-a) advantageously involves at least one item of dissolution equipment, and optionally at least one feedstock preparation device, a mixing device and/or a transportation device. These items of equipment and/or devices may be, for example, a static mixer, an extruder, a pump, a “reactor” (e.g., a stirred vessel), a co-current or counter-current column, or in a combination of lines and of equipment. Devices for transportation in particular of fluids, such as gases, liquids or solids, are well known to those skilled in the art. In a nonlimiting manner, the transportation devices may comprise a compressor, a pump, an extruder, a vibrating tube, an endless screw or a valve. The items of equipment and/or devices may also comprise or be combined with heating systems (for example an oven, a heat exchanger, a tracing, etc.) to achieve the conditions required for dissolution.

The dissolution step S-a) is at least fed with the pre-treated plastic feedstock, in particular in the form of one or more streams of pre-treated plastic feedstock, and with the dissolution solvent, in particular in the form of one or more streams of dissolution solvent, advantageously by means of one or more transportation devices. The stream(s) of pre-treated plastic feedstock may be different from the stream(s) of dissolution solvent. A portion or all of the plastic feedstock may also feed step S-a) as a mixture with a portion or all of the dissolution solvent, the remainder of the solvent and/or of the feedstock, where appropriate, possibly feeding step S-a) separately. During the placing of the pre-treated plastic feedstock in contact with the dissolution solvent, the dissolution solvent is advantageously at least partly, and preferably totally, in liquid form, whereas the pre-treated plastic feedstock, which comprises polymers, in particular thermoplastics, such as polyolefins and notably polypropylene, may be in solid or liquid form optionally comprising solid particles in suspension. The pre-treated plastic feedstock may also optionally be injected into the dissolution equipment, as a mixture with the dissolution solvent, in the form of a suspension in the dissolution solvent, the preparation and injection of the suspension possibly being continuous or batchwise.

Preferably, step S-a) includes at least one extruder and dissolution equipment. In this case, the pre-treated plastic feedstock feeds the extruder such that, at the extruder outlet, at least a portion and preferably all of the targeted polymers, in particular the targeted polypropylene, included in the feedstock are in molten form. The pre-treated plastic feedstock is then injected at least partly in molten form into the dissolution equipment. The pre-treated plastic feedstock, at least partly in molten form, may also be pumped by means of a pump dedicated to viscous fluids, often known as a melt pump or a gear pump. The advantage of the pre-treated plastic feedstock being (at least partly) in molten form is the faster and more homogeneous dissolution of the pre-treated plastic feedstock in the solvent. In this way the residence time in the dissolution step may be reduced, and dissolution is facilitated. The pre-treated plastic feedstock at least partly in molten form may, at the extruder outlet, also be filtered using a filtration device, optionally in addition to the melt pump, for the purpose of removing the coarsest particles; generally, the mesh size of this filter is between 10 microns and 1 mm, preferably between 20 and 200 microns. Preferably, step S-a) includes an extruder into which the dissolution solvent is injected, advantageously at several points, so as to promote shear and thus intimate mixing between the dissolution solvent and the pre-treated plastic feedstock, which contributes towards dissolving the polymers, in particular polypropylene.

The dissolution solvent used in the dissolution step S-a) is an organic solvent or a mixture of solvents that are organic. Preferably, the dissolution solvent is chosen from organic solvents, comprising, and preferentially consisting of, one or more hydrocarbons with a boiling point of between 75° C. and 250° C., preferably between 8° and 220° C. and more preferably between 80° C. and 180° C. Solvents with higher boiling points usually require lower process pressures, and, thus, are advantageous in terms of energy consumption. Further, lower process pressures are preferable since they enable safer process control. The boiling point of the dissolution solvent is to be understood as the boiling point of said dissolution solvent at atmospheric pressure (in particular equal to 0.1 MPa). The dissolution solvent comprises, and preferably consists of, one or more hydrocarbons, preferably one or more alkanes, containing between 6 and 12 carbon atoms and very preferably between 6 and 10 carbon atoms, for example selected from cyclohexane and heptane isomers.

In some embodiments, the dissolution solvent comprises or consists of at least one n-alkane, preferably selected from C7, C8, C9 and C10 n-alkanes or any mixture thereof. In some embodiments, the dissolution solvent comprises or consists of at least one cycloalkane selected from C6, C7, C8, C9 and C10 cycloalkanes or any mixture thereof. In some embodiments, the dissolution solvent comprises or consists of at least one isoalkane selected from C7, C8, C9 and C10 isoalkanes, or any mixture thereof. In some embodiments, the dissolution solvent comprises or consists of at least one n-alkane, preferably selected from C7, C8, C9, C10 n-alkanes and mixtures thereof, at least one cycloalkane, preferably selected from C6, C7, C8, C9, C10 cycloalkanes and mixtures thereof, and/or at least one isoalkane, preferably selected from C7, C8, C9, C10 isoalkanes and mixtures thereof.

Preferably, the dissolution solvent, which is an organic solvent, preferably a hydrocarbon, has a critical temperature of between 9° and 400° C., preferably between 20° and 390° C. and more preferably between 25° and 350° C., and a critical pressure of between 1.5 and 5.0 MPa abs, preferably between 2.0 and 4.3 MPa abs and preferably between 2.4 and 4.2 MPa abs. According to a particular embodiment, the boiling point of the dissolution solvent is greater than 75° C., preferably between 80° C. and 220° C., more preferably between 80° C. and 180° C., and/or the solvent comprises, and preferably consists of, an alkane containing at least 7 carbon atoms. Advantageously, the dissolution is performed at a dissolution temperature of between 100° C. and 300° C., and at a dissolution pressure of between 1.0 and 20.0 MPa abs. More particularly, the temperature and the pressure evolve throughout step S-a), from ambient conditions, i.e. a temperature of the pre-treated plastic feedstock of between 1° and 30° C. and atmospheric pressure (0.1 MPa), until the dissolution conditions are reached, more particularly the dissolution temperature and the dissolution pressure. In particular, the dissolution temperature is between 10° and 300° C., preferably between 15° and 250° C., and the dissolution pressure is between 1.0 and 20.0 MPa abs, preferably between 1.5 and 15.0 MPa abs and very preferably between 2.0 and 10.0 MPa abs. Very advantageously, on conclusion of the dissolution step S-a), the stream of dissolved polymer is at the dissolution temperature and at the dissolution pressure. According to a particular embodiment of the dissolution step S-a), the dissolution pressure is between 1.5 and 2.4 MPa abs, preferably between 1.7 and 2.2 MPa abs. In this very particular embodiment, the water that may be present in the pre-treated plastic feedstock (in the case of a wet plastic feedstock) may then be vaporized and removed during and/or prior to the dissolution by degassing, for example from vents in particular located on the dissolution line and/or equipment, notably on the extruder. When this particular embodiment of the dissolution step S-a) is performed, the process for treating the plastic feedstock according to the present disclosure does not comprise the optional step S-E2) of washing with a dense solution, in particular with an aqueous solution. Limiting the temperature in step S-a), to a temperature of less than or equal to 300° C., preferably less than or equal to 250° C., makes it possible to prevent or to limit the thermal degradation of the polymers, in particular of polypropylene. Preferably, the dissolution temperature is greater than or equal to the melting point of the polymers, in particular of the thermoplastics and more particularly of polypropylene, so as to promote their dissolution. Preferably, the temperature in the dissolution step S-a) is less than or equal to the critical temperature of the dissolution solvent so as to avoid the formation of a supercritical phase during the dissolution step S-a) which is liable to disrupt the dissolution. In parallel, the dissolution pressure is greater than the saturating vapor pressure of the dissolution solvent, at the dissolution temperature, so that the dissolution solvent is at least partly, and preferably totally, in liquid form at the dissolution temperature. Advantageously, the dissolution pressure is greater than or equal to the critical pressure of the dissolution solvent, so as to be able in particular to perform the recovery step S-c) under conditions in which at least a portion of the solvent is in supercritical form without it being necessary to considerably increase the pressure between step S-a), in particular between the outlet of step S-a), and step S-c). In the case where the dissolution pressure in step S-a) is greater than or equal to the critical pressure of the dissolution solvent, the dissolution temperature is less than the critical temperature of the dissolution solvent, so as to keep the dissolution solvent at least partly in liquid form. Very advantageously, the dissolution temperature and pressure conditions reached in step S-a) are adjusted so that the mixture (dissolution solvent+targeted polymers) is a one-phase mixture. Preferably, the weight ratio between the pre-treated plastic feedstock and the dissolution solvent is between 0.01 and 5.0, more preferably between 0.05 and 3.0, and even preferably between 0.10 and 1.0.

Advantageously, said dissolution step S-a) is performed for a residence time of between 1 and 600 minutes, preferably between 2 and 300 minutes, and more preferably between 2 and 180 minutes. The residence time is understood as being the residence time at the dissolution temperature and at the dissolution pressure, i.e. the time of implementation of the pre-treated plastic feedstock with the dissolution solvent at the dissolution temperature and at the dissolution pressure, in step S-a). Advantageously, the dissolution solvent used in step S-a) comprises, and preferably consists of, a supply of fresh solvent and/or a stream of recycled solvent obtained from the recovery step S-c). Optionally, the treatment process may include an intermediate adsorption step S-a′), situated during the dissolution step S-a) or directly downstream of the dissolution step S-a), and which comprises the introduction of adsorbent solid, preferably such as alumina, silica, silica-alumina, active charcoal or decolorizing earth (e.g. bleaching earth), in the form of divided particles, into the crude polymer solution obtained on conclusion of step S-a) or optionally during the dissolution step S-a). The adsorbent solid may then be removed during one of the optional intermediate purification steps, for example during an optional step S-E1) of separation of the insoluble matter and/or an optional washing step S-E2). This optional step S-a′) of adsorption in the presence of adsorbent solid in divided form makes it possible to optimize the purification of the polymer solution.

The crude polymer solution obtained on conclusion of the dissolution step S-a) comprises at least the dissolution solvent, polymers, in particular the targeted polymers that the present disclosure seeks to recover purified, dissolved in the dissolution solvent. In general, the crude polymer solution also comprises soluble impurities that are also dissolved in the dissolution solvent. It may optionally also comprise insoluble impurities or compounds in suspension. The crude polymer solution obtained on conclusion of step S-a) may optionally also comprise polymers, other than the polymers targeted (i.e. other than polypropylene), for example in molten form.

### Optional Step S-E1) of Separating Out the Insoluble Matter

The treatment process may optionally also comprise a step S-E1) of separating out the insoluble matter by solid-liquid separation, to advantageously obtain at least one clarified polymer solution and one insoluble fraction. The insoluble fraction advantageously comprises at least a portion, and preferably all, of the insoluble impurities, notably in suspension in the crude polymer solution obtained from step S-a).

When it is incorporated into the process according to the invention, step S-E1) of separating out the insoluble matter is situated between the dissolution step S-a) and the polymer recovery step S-c), and upstream or downstream of the adsorption step S-b), preferably upstream of the adsorption step S-b). When the optional step S-E1) of separating out the insoluble matter is situated downstream of the adsorption step S-b), the adsorption step S-b) corresponds to the intermediate adsorption step S-a′).

Step S-E1) of separating out the insoluble matter thus makes it possible to remove at least a portion, and preferably all, of the particles of insoluble compounds in the dissolution solvent under the temperature and pressure conditions of step S-a), which may be present in suspension in the crude polymer solution obtained from step S-a) or from an optional step S-a′). The insoluble impurities removed during the optional step S-E1) of separating out the insoluble matter are, for example, pigments, mineral compounds, packaging residues (glass, wood, cardboard, paper, aluminum) and insoluble polymers.

When it is performed, this separation step S-E1) advantageously makes it possible to limit the operating problems, in particular such as clogging and/or erosion, of the downstream process steps, while at the same time contributing towards the purification of the plastic feedstock.

When it is incorporated into the process, step S-E1) of separating out the insoluble matter is advantageously performed at a temperature of between 10° and 300° C., preferably between 150 and 250° C., and at a pressure of between 1.0 and 20.0 MPa abs, preferably between 1.5 and 15.0 MPa abs and very preferably between 2.0 and 10.0 MPa abs. Very advantageously, the optional step S-E1) of separating out the insoluble matter is performed under the dissolution temperature and pressure conditions, i.e., under the temperature and pressure conditions at the outlet of step S-a).

When it is incorporated into the process, said step S-E1) of separating out the insoluble matter is preferably fed with the crude polymer solution obtained from step S-a) or obtained from an optional intermediate adsorption step S-a′). According to another embodiment, the optional step S-E1) may be fed with a washed polymer solution obtained from an optional washing step S-E2).

When it is incorporated into the process, said step S-E1) advantageously includes a section comprising at least one item of solid-liquid separation equipment, for example a separating flask, a decanter, a centrifugal decanter, a centrifuge, a filter, a sand filter, an eddy current separator, an electrostatic separator, a triboelectric separator, preferably a decanter, a filter, a sand filter and/or an electrostatic separator. The removal of the insoluble fraction may be facilitated by equipment for transporting and/or removing the traces of solvent that may be present in the insoluble fraction, for example a 5 conveyor, a vibrating tube, an endless screw, an extruder or a stripper. Step S-E1) may thus include equipment for transporting and/or removing traces of solvent to remove the insoluble fraction.

According to a particular embodiment of the optional step S-E1), step S-E1) of separating out the insoluble matter includes at least two, and generally less than five, items of solid-liquid separation equipment in series and/or in parallel. The presence of at least two items of solid-liquid separation equipment in series makes it possible to improve the removal of the insoluble matter, whereas the presence of equipment in parallel makes it possible to manage the maintenance of said equipment and/or of the unclogging operations.

Certain insoluble compounds, notably certain pigments and mineral fillers, conventionally added during the formulation of polymers, may be introduced in the form of particles less than 1 μm in size. This is the case, for example, for titanium dioxide, calcium carbonate and carbon black. According to a particular embodiment of the optional step S-E1), said step S-E1) of separating out the insoluble matter advantageously includes an electrostatic separator, which makes it possible to efficiently remove at least a portion, preferably all, of the insoluble particles less than 1 μm in size. According to another particular embodiment of the optional step S-E1), step S-E1) of separating out the insoluble matter includes a sand filter, to remove the particles of different sizes and notably the particles less than 1 μm in size.

Depending on the nature of the feedstock, the polymer solution which feeds step S-E1), preferably the crude polymer solution, may optionally also comprise a second liquid phase, for example consisting of molten polymers. According to another particular embodiment of the optional step S-E1), step S-E1) advantageously includes equipment for separating out this second liquid phase, preferably by means of at least one three-phase separator.

### Adsorption Step S-b)

The treatment process according to the present disclosure optionally comprises an adsorption step S-b), to obtain at least one refined polymer solution. The refined polymer solution obtained on conclusion of step S-b) advantageously comprises the targeted polymers that the present disclosure seeks to recover in purified, dissolved form in the dissolution solvent.

The adsorption step S-b) is advantageously performed downstream of the dissolution step S-a) and upstream of the polymer recovery step S-c). The adsorption step S-b) is preferably performed upstream or downstream of an additional purification step. For example, it may be performed upstream of an optional step S-E1) and/or S-E2) and correspond in particular to the optional intermediate adsorption step S-a′). It may also be performed, for example, upstream or downstream of an optional extraction step S-E3). Thus, the adsorption step S-b) is performed by placing the polymer solution which feeds step S-b), in particular the crude polymer solution obtained from step S-a), the clarified polymer solution obtained from the optional step S-E1) or the washed polymer solution obtained from the optional step S-E2) or else the extracted polymer solution obtained from the optional step S-E3), in contact with one or more adsorbents.

Said adsorption step S-b) advantageously includes an adsorption section operated in the presence of at least one adsorbent, which is preferably solid, and in particular in the form of a fixed bed, an entrained bed (or slurry, i.e., in the form of particles introduced into the stream to be purified and entrained with this stream) or in the form of an ebullated bed, preferably in the form of a fixed bed or an entrained bed. The adsorbent(s) used in step S-b) are preferably an alumina, a silica, a silica-alumina, an active charcoal, a decolorizing earth, or mixtures thereof, preferably an active charcoal, a decolorizing earth or mixtures thereof, preferably in the form of a fixed bed or an entrained bed, the circulation of the streams possibly being ascending or descending.

Advantageously, the adsorption step S-b) is performed at a temperature of between 10° and 300° C., preferably between 15° and 250° C., and at a pressure of between 1.0 and 20.0 MPa abs, preferably between 1.5 and 15.0 MPa abs and very preferably between 2.0 and 10.0 MPa abs. Very advantageously, the adsorption step S-b) is performed under the dissolution temperature and pressure conditions, i.e., at the dissolution temperature and the dissolution pressure reached in step S-a). Preferably, in step S-b), the hourly space velocity (or HSV), which corresponds to the ratio between the volume flow rate of the polymer solution which feeds step S-b) and the volume of adsorbent, is between 0.05 and 10 h⁻¹, preferably between 0.1 and 5.0 h⁻¹.

The adsorption section of step S-b) may, according to another embodiment, consist of adding adsorbent particles to the polymer solution, in particular the crude polymer solution, said particles possibly being separated from the polymer solution via a step of removing the adsorbent particles located downstream of said adsorption section. The removal of the adsorbent particles may then advantageously correspond to a step S-E1) of separating out the insoluble matter or to the washing step S-E2). Such an implementation of the adsorption step S-b), by introducing the adsorbent particles followed by solid/liquid separation, advantageously corresponds to the optional intermediate adsorption step S-a′), described earlier in the present description.

### Step S-c) of Recovery of the Polymers

According to the present disclosure, the process comprises a step S-c) of recovering polymers, to obtain at least one solvent fraction and one purified polymer fraction to obtain the polymer composition comprising a post-consumer polypropylene recycled resin. The polymer recovery step S-c) advantageously includes at least one solvent recovery section, preferably between one and six solvent recovery sections, more preferably two, three, four or five solvent recovery sections. The polymer recovery step S-c) is fed with the refined polymer solution or optionally the extracted polymer solution.

The polymer recovery step S-c) is thus first directed towards at least partly, preferably predominantly, separating out the solvent(s), in particular the dissolution solvent, contained in the polymer solution which feeds step S-c), i.e., the refined polymer solution or optionally the extracted polymer solution, so as to recover the polymers, at least partly, preferably predominantly and more preferably totally, free of the dissolution solvent and of the other solvent(s) used in the process that may still be present in the polymer solution which feeds step S-c), for example the extraction solvent. The term “predominantly” should be understood as meaning at least 50% by weight, preferably at least 70% by weight, more preferably at least 90% by weight, very preferably at least 95%, relative to the weight of the solvent(s) contained in the polymer solution which feeds step S-c), in particular of the dissolution solvent and optionally of the extraction solvent contained in the refined polymer solution or optionally the extracted polymer solution which feeds step S-c). Any method for separating the solvent from the polymers which is known to those skilled in the art may be performed, notably any method enabling a phase change of the polymers or of the solvent(s). The solvent(s) may be separated out, for example, by evaporation and/or flash devolatization, stripping, demixing, a difference in density and notably decantation or centrifugation, etc. In a preferred embodiment, polymers are recovered in at least one solvent recovery sections, particularly two, three or four solvent recovery sections, by evaporation and/or flash devolatization at a temperature within the range of from 100 to 300° C., preferably from 110 to 275° C., more preferably from 150 to 250° C., and at a pressure within the range of from 10 Pa to 4 MPa abs, preferably from 0.1 kPa to 4 MPa abs, particularly from 0.1 kPa to 2 MPa abs. In a specific embodiment, the polymer recovery step S-c) includes three or four solvent recovery sections of flash devolatization, wherein a first flash devolatization is performed at a temperature of within the range of from 110 to 275° C. and at a pressure of within the range of from 0.8 kPa to 2 MPa abs, particularly from 0.1 MPa to 2 MPa abs, a last flash devolatization is performed (i.e., respectively a third or fourth flash devolatization) at a temperature of within the range of from 110 to 275° C. and at a pressure of within the range of from 0.1 kPa to 1 MPa abs, particularly from 0.1 kPa to 0.1 MPa abs, and intermediate flash devolatization(s) is (are) performed at a temperature of within the range of from 110 to 275° C. and at a pressure of between the pressure of the first flash devolatization and the last flash devolatization and such that the pressure decreases from the first to the last flash devolatization. To protect the recycled polypropylene resin from thermal degradation, thermal stabilizers (e.g. Irganox 1076 and/or Irgafos 168) may advantageously be added to the refined polymer solution resulting from step S-b) prior to separating out the solvent(s) therefrom in step S-c).

The purified polymer fraction obtained may correspond to a concentrated polymer solution or to solid purified polymers.

According to a particular embodiment of the present disclosure, at least a portion of the purified polymer fraction obtained on conclusion of step S-c) may be recycled into the dissolution step S-a), to undergo once again a treatment cycle so as to increase the polymer purification efficiency.

After the solvent separation of step S-c), the solvent content is normally less than 5 wt %, preferably less than 2 wt % and more preferably less than 1 wt % of the total weight of the purified polymer fraction.

### Melt-Processing, Step C)

The purified polymer fraction comprising a post-consumer polypropylene recycled resin obtained from step S-c) of the solvent-based recycling process is subjected to the following steps:
C-a) further separating solvent from the purified polymer fraction, preferably by evaporation (herein referred to as degassing) and/or flash devolatization of the solvent;
C-b) melt-processing, preferably melt-extruding and/or pelletizing, the purified polymer fraction, preferably further comprising adding additives, to form a melt-processed, preferably melt-extruded and/or pelletized, recycled polypropylene product;
C-c) optionally aerating the recycled polypropylene product to remove volatile organic compounds, thereby generating an aerated melt-processed, preferably melt-extruded and/or pelletized, recycled polypropylene product
   to obtain a polymer composition, i.e., a melt-processed polymer composition, comprising a post-consumer recycled polypropylene resin of the present disclosure.
   Step C-a) of Further Separating Solvent from the Purified Polymer Fraction

According to the present disclosure, the process comprises further separating solvent from the purified polymer fraction, preferably by evaporation and/or devolatization of the solvent by methods known to the person skilled in the art. After the solvent separation, the solvent content is normally less than 2,000 ppm, preferably less than 1,000 ppm and more preferably less than 500 ppm of the total weight of the purified polymer fraction.

This step of further solvent separation (degassing) from the purified polymer fraction assists in removal of residual contaminants with high boiling points, such as limonene, n-hexanal, toluene and other odor active substances.

Step C-a) of further separating solvent from the purified polymer fraction may be performed simultaneously with step C-b) of melt-processing the purified polymer fraction. Thus, further separating solvent from the purified polymer fraction may be performed during melt-processing of the purified polymer fraction.

In preferred embodiments, further separating solvent from the purified polymer fraction is performed during melt-processing of the purified polymer fraction in an extruder with degassing ports (as further described below), the extrusion preferably being performed at a temperature within the range of from 220 to 280° C., preferably from 240 to 270° C., and with a pressure at the degassing ports within the range of from 0.5 kPa to 0.1 MPa abs, preferably from 1 kPa to 50 kPa abs, more preferably from 1 kPa to 10 kPa abs.

Generally, the solvent content of the melt-extruded purified polymer fraction after said degassing may be within the range of from 100 to 500 ppm, such as from 300 to 500 ppm, based on the total weight of the purified polymer fraction.

### Step C-b) of Melt-Processing the Purified Polymer Fraction

According to the present disclosure, the process comprises melt-processing, preferably melt-extruding and/or pelletizing, the purified polymer fraction, preferably comprising adding additives, to form a melt-processed, preferably melt-extruded, and/or pelletized, recycled polypropylene product as the melt-processed polymer composition of the present disclosure, comprising a post-consumer recycled polypropylene resin of the present disclosure. The optional additives may be added in the melt state or in solid state to be melted within the polymer melt, preferably in melt state.

Step C-b is preferably performed in a single or twin screw extruder, preferably combined with a suitable pelletizing system. The extruder may be designed for degassing (as disclosed above) and optionally mixing with additives such as polymer stabilizers. Screw speed of the extruder may be within the range of from 50 to 500 rpm. The dimensionless throughput, Q, of the extruder may be within the range of from 0.02 to 0.15, preferably from 0.03 to 0.12, more preferably from 0.03 to 0.10. The target melt temperature of the purified polymer fraction is generally within the range of from 190 to 280° C., preferably from 220 to 280° C., more preferably from 240 to 270° C.

In embodiments where the purified polymer fraction is melt-extruded, the extruder may include up to four, such as two or three, degassing ports for top and/or side degassing. The absolute pressure at the degassing ports may be within the range of from 0.5 kPa to 0.1 MPa abs, preferably from 1 kPa to 50 kPa abs, more preferably from 1 kPa to 10 kPa abs, which may be achieved with a suitable vacuum system, e.g. with one or more vacuum pumps.

Degassing may be improved by adding 0.01-1 wt %, based on the weight of the purified polymer fraction, of a stripping agent, such as an alcohol (e.g. ethanol or isopropanol), supercritical carbon dioxide, water or any combinations thereof. The stripping agent is preferably water. The stripping agent(s) may be injected into the extruder under pressure with suitable pumps. In embodiments where the extruder includes three degassing ports, within the range of from 0.01 to 1 wt %, based on the weight of the purified polymer fraction, of a stripping agent, such as water, is preferably added in the second and third degassing port, respectively.

Pelletizing the melt-processed polymer composition may be performed using a suitable pelletizing system as well known to those skilled in the art, e.g. selected from underwater-, strand-, or watering pelletizing systems. Optionally, a gear melt pump can be used to overcome the pressure drop of the die plate of the pelletizer, to prevent excessive energy input from pressurizing with the extruder, and, in turn, increasing melt temperatures and risk of polymer degradation. This may be particularly advantageous for high output lines with big die plates generating substantial pressure drop (e.g. >30 bar). The gear melt pump may also prevent filling of the extruder screw(s) backwards and flooding of degassing ports, which risk resulting in ineffective degassing and in the worst case stopping of the line.

### Step C-c) of Aerating the Recycled Polypropylene Product

According to the present disclosure, the process may comprise aerating the recycled polypropylene product to remove any remaining volatile organic compounds, thereby generating an aerated melt-processed, preferably melt-extruded and/or pelletized, recycled polypropylene product as the polymer composition of the present disclosure, comprising a post-consumer recycled polypropylene resin of the present disclosure. Aeration may be performed by heating the recycled polypropylene product to a temperature above 100° C., such as within the range of from 110 to 130° C.

After the aeration, the solvent content is normally less than 300 ppm by weight, preferably less than 200 ppm by weight, more preferably less than 100 ppm by weight. Generally, the solvent content after aeration may be within the range of from 20 to 100, ppm by weight based on the total weight of the recycled polypropylene product.

According to the present disclosure, a particular embodiment refers to a process of preparing a polymer composition comprising, preferably at least 95 wt %, based on the total weight of the polymer composition, a post-consumer recycled polypropylene resin, said process comprising the steps of
M) pre-treating a plastic feedstock by subjecting the plastic feedstock to mechanical recycling process, comprising sieving, sorting by at least one of polymer type, polymer article form, and/or color, shredding, and optionally cleaning, e.g. washing, the plastic feedstock to obtain a pre-treated plastic feedstock, and optionally melting the pre-treated plastic feedstock;
S) subjecting the optionally molten pre-treated plastic feedstock to solvent-based recycling process to obtain the post-consumer recycled polypropylene resin accomplished by dissolving a plastic feedstock comprising polypropylene in a solvent and separating non-dissolved components and soluble impurities, wherein step S) comprises
S-a) a dissolution step in which the pre-treated plastic feedstock is placed in contact with a dissolution solvent at a dissolution temperature of between 100° C. and 300° C. and a dissolution pressure of between 1.0 and 20.0 MPa abs, to obtain at least one, preferably one, crude polymer solution, wherein the dissolution solvent is chosen from organic solvents comprising one or more hydrocarbons with a boiling point of between 75° C. and 250° C. to obtain at least one crude polymer solution;
S-b) optionally a step of adsorption by placing the crude polymer solution obtained from step S-a) in contact with at least one adsorbent, at a temperature of between 10° and 300° C. and a pressure of between 1.0 and 20.0 MPa abs, to obtain at least one refined polymer solution; and
S-c) a step of recovering polymers to obtain at least one solvent fraction and one purified polymer fraction in at least one solvent recovery sections, particularly two or three solvent recovery sections, by evaporation and/or flash devolatization at a temperature within the range of from 100 to 300° C., preferably from 110 to 275° C., and at a pressure within the range of from 10 Pa to 4 MPa abs, preferably from 0.1 kPa to 4 MPa abs, particularly from 0.1 kPa to 2 MPa abs; and
C) melt-processing the post-consumer recycled polypropylene resin obtained from step S), wherein step C) comprises
C-a) further separating solvent from the purified polymer fraction, and
C-b) melt-processing the purified polymer fraction,
   wherein further separating solvent from the purified polymer fraction is performed during melt-processing the purified polymer fraction in an extruder with degassing ports at a temperature within the range of from 220 to 280° C., preferably from 240 to 270° C., and at a pressure at the degassing ports within the range of from 0.5 kPa to 0.1 MPa abs, preferably from 1 kPa to 50 kPa abs, more preferably from 1 kPa to 10 kPa abs,
   to obtain said polymer composition.

### The Polymer Composition

The present disclosure provides a process of preparing a polymer composition. The polymer composition provided by the process according to the present disclosure comprises, preferably consists of, a post-consumer recycled polypropylene resin. The polymer composition is a melt-processed, preferably melt-extruded, polymer composition.

Advantageously, the polymer composition provided by the process according to the present disclosure comprises at least 95 wt %, preferably at least 97 wt %, more preferably at least 98 wt %, even more preferably at least 99 wt %, of a post-consumer recycled polypropylene resin of the total weight of the polymer composition. In some embodiments, the polymer composition provided by the process according to the present invention comprises a post-consumer recycled polypropylene resin as the single polymer component. According to another embodiment, the polymer composition essentially consists of the post-consumer recycled polypropylene resin. In that case, the post-consumer recycled polypropylene resin represents all polymeric material present in the entire composition.

It is understood that additives, such as polymer stabilizers, in a low content of up to 5 wt %, preferably up to 3 wt %, more preferably up to 2 wt %, even more preferably up to 1 wt %, based on the total weight of the polymer composition, may be present in the polymer composition. In an aspect of the present description, the polymer composition consists of a post-consumer recycled polypropylene resin and optionally polymer additives in these low contents. Generally, additives in a low content of up to 5 wt % do not significantly alter the properties of the polymer composition. In particular, the properties described in the present disclosure are not significantly altered by additivation. This means that the described properties which are based on the total weight of the polymer composition generally have similar, or in some cases even identical, values if measured on the post-consumer recycled polypropylene resin directly. Examples of additives are primary antioxidants, such as a sterically hindered phenol including octadecyl 3-(3′,5′-di-tertbutyl-4-hydroxyphenyl)propionate] (e.g. Irganox 1076), 2,2′-thiodiethylenebis-(3,5-di-tertbutyl-4-hydroxyphenyl)-propionate (e.g. Irganox 1330FF), 2,5,7,8-Tetramethyl-2 (4′,8′,12′-trimethyltridecyl) chroman-6-ol (e.g. Irganox E 201) and secondary antioxidants, such as phosphites (e.g. Irgafos 168) or phosphonites.

Preferably, the contents of compounds comprised in the post-consumer recycled polypropylene resin as described below are similar or at least not higher in the respective polymer composition, preferably melt-processed polymer composition.

### Post-Consumer Recycled (PCR) Polypropylene Resin

According to the present invention, the post-consumer recycled (PCR) polypropylene resin denotes a resin comprising at least one post-consumer recycled polypropylene, i.e., a polypropylene obtained from post-consumer waste. Preferably, the post-consumer recycled polypropylene resin comprises at least 80 wt % and preferably up to 100 wt %, such as 80 to 99 wt %, preferably at least 90 wt %, more preferably at least 95 wt %, of at least one post-consumer recycled polypropylene, i.e., a polypropylene obtained from post-consumer waste, of the total weight of the post-consumer recycled polypropylene resin, determined by Fourier transform infrared (FTIR) spectroscopy.

Thus, the post-consumer recycled polypropylene resin has already completed at least a first use cycle (or life cycle), i.e., having already served its first purpose. The post-consumer recycled polypropylene resin is different from virgin polypropylene resin, i.e., a newly produced material, which has not already been recycled. The post-consumer recycled polypropylene resin is also different from industrial waste, i.e., manufacturing scrap, which does normally not reach a consumer.

The post-consumer recycled (PCR) polypropylene resin of the polypropylene composition provided by the process according to the present invention is preferably prepared from plastic feedstock, comprising, preferably consisting of, plastic waste, such as post-consumer waste, comprising at least polypropylene, by a process comprising mechanical recycling step(s) and solvent-based recycling step(s), in combination with melt-processing process steps as discussed herein.

Generally, virgin polymer materials and mechanically recycled polymer materials can easily be differentiated based on the absence or presence of contaminants such as limonene, fatty acids, paper and/or wood and other contaminants, or generally on their ash content. Polypropylenes can further be differentiated with respect to the origin of the materials by the possible presence of non-polyolefin polymers such as polystyrene and/or polyamide. However, the present post-consumer recycled resin is comparable to virgin polypropylenes in many of these conventional differentiating characteristics.

The post-consumer recycled polypropylene resin of the polymer composition provided by the process according to the present disclosure can be differentiated from virgin polypropylene preferably by an ethylene content (C2(CF)) of the crystalline fraction (CF), being in the range of from [C2-3.4] to [C2-0.2] wt %, more preferably from [C2-3.0] to [C2-0.6] wt %, and most preferably from [C2-2.4] to [C2-1.2] wt %, of the total weight of the crystalline fraction of the post-consumer recycled polypropylene resin, as determined according to Crystex analysis described herein. C2 represents here the value obtained for the ethylene content of the respective polymer, as described further below.

In other words, the ethylene content (C2(CF)) of the crystalline fraction (CF) preferably is, in wt % of the total weight of the crystalline fraction of the post-consumer recycled polypropylene resin, [−3.4+C2]<C2(CF)<[−0.2+C2], more preferably [−3.0+C2]<C2(CF)<[−0.6+C2], and most preferably [−2.4+C2]<C2(CF)<[−1.2+C2].

Similarly, the polymer composition resulting from the present process can be differentiated from virgin polypropylene (compositions) preferably by an ethylene content (C2(CF)) of the crystalline fraction (CF), being in the range of from [C2-3.4] to [C2-0.2] wt %, more preferably from [C2-3.0] to [C2-0.6] wt %, and most preferably from [C2-2.4] to [C2-1.2] wt % of the total weight of the crystalline fraction of the polymer composition.

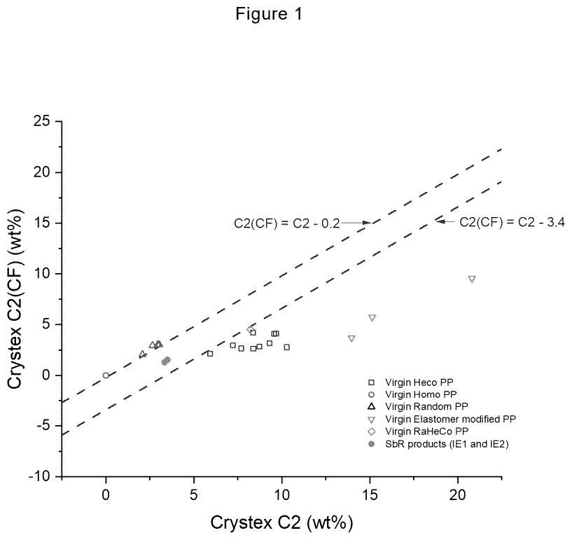

As can be seen in FIG. 1, the relationship between the ethylene content of the crystalline fraction and the ethylene content of the polymer sample differs between recycled polypropylene polymers (SbR products) and virgin polypropylene polymer.

The polymer composition provided by the process according to the present invention may further be differentiated from mechanically recycled polypropylene (compositions) by the content of gamma phase as measured by wide-angle X-ray scattering (WAXS). It has been found that polypropylene recyclates obtained via a solvent based recycling process generally contain a much lower content of gamma phase in the crystalline structure (measured by WAXS) than corresponding polypropylene recyclate obtained from a mechanical recycling process.

Preferably, the post-consumer recycled polypropylene resin comprises, based on the total weight of the post-consumer recycled polypropylene resin, and determined by Fourier transform infrared (FTIR) spectroscopy, at least 80 wt %, more preferably at least 85 wt %, and even more preferably at least 90 wt %, and preferably up to 100 wt. %, of one or more propylene (co) polymer component(s). The wording propylene (co) polymer component(s) denotes propylene homopolymer component(s) and/or propylene copolymer component(s).

Also preferably, the polymer composition comprises, based on the total weight of the polymer composition, and determined by Fourier transform infrared (FTIR) spectroscopy, at least 80 wt %, more preferably at least 85 wt %, and even more preferably at least 90 wt %, and preferably up to 100 wt. %, of one or more propylene (co) polymer component(s).

Preferably, the polymer composition comprises from 0 to 1 wt % of non-polyolefin polymers, of the total weight of the polymer composition, as determined by Fourier transform infrared (FTIR) spectroscopy. More preferably, polyamide (PA) and/or polystyrene (PS) polymer(s) is/are not determinable by FTIR spectroscopy in the polymer composition. Further preferably, PET and/or PVC is/are not determinable by FTIR spectroscopy in the polymer composition. Most preferably none of PA, PS; PET and PVC are determinable by FTIR spectroscopy in the polymer composition.

Particularly, the post-consumer recycled polypropylene resin comprises from 0 to 1 wt % of non-polyolefin polymers, of the total weight of the post-consumer recycled polypropylene resin, as determined by Fourier transform infrared (FTIR) spectroscopy. More preferably, polyamide (PA) and/or polystyrene (PS) polymer(s) is/are not determinable by FTIR spectroscopy in the post-consumer recycled polypropylene resin. Further preferably, PET and/or PVC is/are not determinable by FTIR spectroscopy in the post-consumer recycled polypropylene resin. Most preferably none of PA, PS; PET and PVC are determinable by FTIR spectroscopy in the post-consumer recycled polypropylene resin.

The post-consumer recycled polypropylene resin, and thus also the polymer composition, preferably comprises a mixture, such as a polymer blend, of one or more propylene (co) polymer component(s), comprising propylene homopolymer components and/or propylene copolymer components.

The expression “propylene homopolymer” denotes a propylene polymer that consists of at least 99.0 wt %, preferably at least 99.5 wt %, more preferably at least 99.8 wt % of propylene monomer units, based on the total weight of the propylene polymer, determined by quantitative ¹³C{¹H} nuclear magnetic resonance (NMR) spectroscopy. In one embodiment, only propylene monomer units are detectable in the propylene homopolymer.

Based on its crystalline structure, a propylene homopolymer may be present as isotactic, syndiotactic, and/or atactic propylene homopolymer.

The expression “propylene copolymer” denotes a propylene polymer that generally comprises propylene monomer units and other comonomer units, preferably, ethylene comonomer units and/or one or more alpha-olefin(s) comonomer units having from 4 to 10 carbon atoms, most preferably ethylene comonomer units. Preferably, the content of the propylene monomer units in the propylene copolymer is at least 70 wt %, based on the total weight of the propylene copolymer, determined by quantitative ¹³C{¹H}-NMR spectroscopy, or alternatively 70 mol-%, based on the total molar content of the propylene copolymer, determined by quantitative ¹³C{¹H}-NMR spectroscopy.

In some embodiments, the polymer composition comprises less than 12 wt %, more preferably less than 10 wt %, and most preferably less than 9 wt %, and typically at least 0.1 wt %, of an ethylene propylene rubber (EPR), of the total weight of the polymer composition, determined by Cross Fractionation Chromatography (CFC) analysis as described herein.

Particularly, the post-consumer recycled polypropylene resin comprises less than 12 wt %, more preferably less than 10 wt %, and most preferably less than 9 wt %, and typically at least 0.1 wt %, of an ethylene propylene rubber (EPR), of the total weight of the post-consumer recycled polypropylene resin, determined by Cross Fractionation Chromatography (CFC) analysis as described herein.

The content of ethylene comonomer, based on the total weight of the ethylene propylene rubber, and determined by IR detector, may be in the range of from 15 to 50 wt %.

The polymer composition may further comprise, up to 10 wt %, more preferably up to 6 wt %, and most preferably up to 4 wt %, of one or more ethylene (co) polymer components, comprising ethylene homopolymer components and ethylene copolymer components comprising ethylene monomer units and one or more alpha-olefin(s) comonomer units having from 4 to 10 carbon atoms, of the total weight of the polymer composition, determined by quantitative ¹³C{¹H}-NMR spectroscopy.

Particularly, the post-consumer recycled polypropylene resin comprises up to 10 wt %, more preferably up to 6 wt %, and most preferably up to 4 wt %, of one or more ethylene (co) polymer components, comprising ethylene homopolymer components and ethylene copolymer components comprising ethylene monomer units and one or more alpha-olefin(s) comonomer units having from 4 to 10 carbon atoms, of the total weight of the post-consumer recycled polypropylene resin, determined by quantitative ¹³C{¹H}-NMR spectroscopy.

In some embodiments, the polymer composition comprises, based on the total weight of the polymer composition, and determined by Cross Fractionation Chromatography (CFC) analysis as described herein, from 0.1 to 1.0 wt %, preferably from 0.2 to 0.5 wt %, of high crystalline fraction (HCF) ethylene polymer and/or 1.0 to 5.0 wt %, preferably from 2.0 to 3.5 wt %, of low crystalline fraction (LCF) ethylene polymer.

Particularly, the post-consumer recycled polypropylene resin comprises, based on the total weight of the post-consumer recycled polypropylene resin, and determined by Cross Fractionation Chromatography (CFC) analysis as described herein, from 0.1 to 1.0 wt %, preferably from 0.2 to 0.5 wt %, of high crystalline fraction (HCF) ethylene polymer and/or 1.0 to 5.0 wt %, preferably from 2.0 to 3.5 wt %, of low crystalline fraction (LCF) ethylene polymer.

As a direct determination of the propylene (co) polymer or ethylene (co) polymer content is not possible, the weight contents are determined from equivalent ratio from calibration by isotactic polypropylene (iPP) homopolymer and high-density polyethylene (HDPE).

The propylene (co) polymer components are preferably of high-degree crystallinity as defined below. However, less crystalline or non-crystalline copolymer components may also be present in the post-consumer recycled polypropylene resin, and thus also in the polymer composition.

Preferably, the polymer composition comprises a crystalline fraction (CF), in an amount from 85 to 95 wt %, more preferably from 87 to 94 wt %, and most preferably from 88 to 93 wt %, of the total weight of the polymer composition, determined according to Crystex analysis described herein.

Particularly, the post-consumer recycled polypropylene resin comprises a crystalline fraction (CF), in an amount from 85 to 95 wt %, more preferably from 87 to 94 wt %, and most preferably from 88 to 93 wt %, of the total weight of the post-consumer recycled polypropylene resin, determined according to Crystex analysis described herein.

The less crystalline or non-crystalline copolymer components make up the majority of the soluble fraction (SF), and they are preferably present in an amount from 5 to 15 wt %, more preferably from 6 to 13 wt %, even more preferably from 7 to 12 wt %, of the total weight of the polymer composition, determined according to Crystex analysis described herein. Particularly, they are present in an amount from 5 to 15 wt %, more preferably from 6 to 13 wt %, even more preferably from 7 to 12 wt %, of the total weight of the post-consumer recycled polypropylene resin, determined according to Crystex analysis described herein.

In some embodiment, the polymer composition comprises an ethylene content (C2), in an amount from 1.5 to 10.0 wt %, preferably from 2.0 to 8.0 wt %, and more preferably from 2.0 to 7.0 wt %, of the total weight of the polymer composition, determined according to Crystex analysis described herein.

Particularly, the post-consumer recycled polypropylene resin comprises an ethylene content (C2), in an amount from 1.5 to 10.0 wt %, preferably from 2.0 to 8.0 wt %, and more preferably from 2.0 to 7.0 wt %, of the total weight of the post-consumer recycled polypropylene resin, determined according to Crystex analysis described herein.

In some embodiment, the polymer composition comprises an ethylene content of the crystalline fraction (C2(CF)), in an amount from 0.3 to 5 wt %, preferably from 0.4 to 4 wt %, and more preferably from 0.5 to 3 wt %, of the total weight of the crystalline fraction of the polymer composition, determined according to Crystex analysis described herein.

Particularly, the post-consumer recycled polypropylene resin comprises an ethylene content of the crystalline fraction (C2(CF)), in an amount from 0.3 to 5 wt %, preferably from 0.4 to 4 wt %, and more preferably from 0.5 to 3 wt %, of the total weight of the crystalline fraction of the post-consumer recycled polypropylene resin, determined according to Crystex analysis described herein.

In some embodiment, the polymer composition comprises an ethylene content of the soluble fraction (C2(SF)), in an amount from 10 to 40 wt %, preferably from 15 to 35 wt %, and more preferably from 20 to 30 wt %, of the total weight of the soluble fraction of the polymer composition, determined according to Crystex analysis described herein.

Particularly, the post-consumer recycled polypropylene resin comprises an ethylene content of the soluble fraction (C2(SF)), in an amount from 10 to 40 wt %, preferably from 15 to 35 wt %, and more preferably from 20 to 30 wt %, of the total weight of the soluble fraction of the post-consumer recycled polypropylene resin, determined according to Crystex analysis described herein.

In some embodiments, the polymer composition, particularly the post-consumer recycled polypropylene resin thereof, comprises an intrinsic viscosity of the soluble fraction (IV(SF)), in the range of from 0.8 to 3.0 dl/g, preferably from 0.9 to 2.5 dl/g, and more preferably from 1 to 2 dl/g, determined according to Crystex analysis described herein.

Advantageously, the polymer composition, particularly the post-consumer recycled polypropylene resin thereof, comprises a ratio of molecular weight of the soluble fraction (SF) to the molecular weight of the ethylene polymer (PE): Mw(SF)/Mw(PE) of more than 2, and also preferably less than 5, determined by Cross Fractionation Chromatography (CFC) analysis as described herein. Higher Mw(SF)/Mw(PE) values mean that the composition is cleaned from the high molecular weight ethylene polymer fractions, while the EPR (ethylene propylene rubber) fraction of high molecular weight is maintained. Due to the high intrinsic viscosity in EPR, positive properties are conferred to the composition.

Preferably, the (weight average) molecular weight (Mw) of the soluble fraction (SF) of the polymer composition, particularly the post-consumer recycled polypropylene resin thereof, determined by Cross Fractionation Chromatography (CFC) analysis as described herein, is in the range of from 100 to 350 kg/mol, more preferably from 110 to 200 kg/mol, and most preferably from 120 to 180 kg/mol.

Preferably, the (weight average) molecular weight (Mw) of the ethylene polymer (PE) of the polymer composition, particularly the post-consumer recycled polypropylene resin thereof, determined by Cross Fractionation Chromatography (CFC) analysis as described herein, is in the range of from 20 to 100 kg/mol, more preferably from 25 to 80 kg/mol, and most preferably from 30 to 60 kg/mol.

The present polymer composition, particularly the post-consumer recycled polypropylene resin thereof, is advantageously quasi polyethylene free described by the low C2 content in the TREF fraction between 7° and 95° C. and the high PEP/EEE ratio.

In some embodiments, the polymer composition, particularly the post-consumer recycled polypropylene resin thereof, comprises for the Temperature Rising Elution Fractionation (TREF) fraction eluting between 7° and 95° C., in which high molar mass PE, EP copolymer and low MW i-PP are eluting, a low ethylene content below 34 wt % C2, preferably less than 30 wt % C2, more preferably less than 25 wt % C2, and even more preferably less than 16 wt % C2, and also preferably more than 2.5 wt %, determined by Cross Fractionation Chromatography (CFC) analysis described herein.

In some embodiments, the polymer composition, particularly the post-consumer recycled polypropylene resin thereof, comprises a ratio of the comonomer sequence distribution at the triad level PEP/EEE of more than 0.3, preferably more than 0.4, determined by quantitative ¹³C{¹H} NMR spectroscopy described herein. EEE depicts a triad ethylene block, while PEP depicts a propylene-ethylene-propylene block.

### Contaminants

The polymer composition comprising the post-consumer recycled polypropylene resin provided by the process according to the present disclosure is characterized by a very low content of contaminants. This enables its use in a variety of applications. Preferably, the metal content of the polymer composition, particularly the post-consumer recycled polypropylene resin thereof, is very low. For some contaminants, the content in the polymer composition, particularly the post-consumer recycled polypropylene resin thereof, is lower than in virgin polypropylene polymers. In particular, the content of metals used in co-catalysts is reduced.

The present polymer composition preferably has a very low content of ash, which is comparable to virgin polypropylenes. Preferably, the content of other contaminants is also very low. The contaminant contents are described for the polymer composition in the following. The contaminant contents in the post-consumer recycled polypropylene resin are similarly low, i.e., are contained in the same maximum contents and ranges in the post-consumer recycled polypropylene resin.

In some embodiments, the polymer composition has an ash content of up to 0.07 wt %, more preferably up to 0.06 wt %, and even more preferably up to 0.05 wt % of the total weight of the polymer composition, as determined according to Thermogravimetric Analysis (TGA) as described herein. In other words, the ash content is preferably in the range of from 0 to up to 0.07 wt %, more preferably 0 to up to 0.06 wt %, and even more preferably 0 to up to 0.05 wt % of the total weight of the polymer composition.

Particularly, the post-consumer recycled polypropylene resin preferably has an ash content of up to 0.07 wt %, more preferably up to 0.06 wt %, and even more preferably up to 0.05 wt % of the total weight of the post-consumer recycled polypropylene resin, as determined according to Thermogravimetric Analysis (TGA) as described herein. In other words, the ash content is preferably in the range of from 0 to up to 0.07 wt %, more preferably 0 to up to 0.06 wt %, and even more preferably 0 to up to 0.05 wt % of the total weight of the post-consumer recycled polypropylene resin.

Thus, the ash content of the post-consumer recycled polypropylene resin, and thus also of the polymer composition, provided by the process according to the present disclosure is usually very low. The ash content is indicative of the purity grade of a material. Generally, such low ash contents are only obtained for virgin polymers and rather not in recycled materials. The high-purity grade of the post-consumer recycled polypropylene resin and of the polymer composition provided by the process according to the present disclosure, enables the use of the polymer composition in a variety of applications. For example, use is possible in application, where contaminants could negatively affect the production or handling of an article. Further, use in applications may also be considered where recycled polymers are yet not approved per regulations due to undefined contents of contaminants (e.g., in food industry). Accordingly, the polymer composition provided by the process according to the present disclosure allows for application of recycled polymers in areas where their application may not yet have been possible.

In some embodiments, the polymer composition has a heavy metal content (w/w) of less than 10 ppm, preferably less than 5 ppm, of the total weight of the polymer composition, determined as the sum of the metal contents of cadmium (Cd), chromium (Cr), mercury (Hg) and lead (Pb) by X-Ray Fluorescence (XRF) Spectroscopy. In more preferred embodiments, no cadmium, chromium, mercury and/or lead is/are determinable by X-Ray Fluorescence (XRF) Spectroscopy.

Particularly, the post-consumer recycled polypropylene resin has a heavy metal content (w/w) of less than 10 ppm, preferably less than 5 ppm, of the total weight of the post-consumer recycled polypropylene resin, determined as the sum of the metal contents of cadmium (Cd), chromium (Cr), mercury (Hg) and lead (Pb) by X-Ray Fluorescence (XRF) Spectroscopy. In more preferred embodiments, no cadmium, chromium, mercury and/or lead is/are determinable by X-Ray Fluorescence (XRF) Spectroscopy.

In some embodiments, the polymer composition has a titanium (Ti) content (w/w) of less than 100 ppm, preferably less than 50 ppm, and more preferably less than 20 ppm, of the total weight of the polymer composition, determined by X-Ray Fluorescence (XRF) Spectroscopy.

Particularly, the post-consumer recycled polypropylene resin has a titanium (Ti) content (w/w) of less than 100 ppm, preferably less than 50 ppm, and more preferably less than 20 ppm, of the total weight of the post-consumer recycled polypropylene resin determined by X-Ray Fluorescence (XRF) Spectroscopy.

The low titanium content is indicative of low contents of filler (e.g., titanium dioxide) in the polymer composition.

In some embodiments, the polymer composition has a content (w/w) of at least one of aluminum (Al), calcium (Ca) or chlorine (CI) of less than 40 ppm, preferably less than 30 ppm and more preferably less than 20 ppm, of total weight of the polymer composition, determined by X-Ray Fluorescence (XRF) Spectroscopy.

Particularly, the post-consumer recycled polypropylene resin has a content (w/w) of at least one of aluminum (Al), calcium (Ca) or chlorine (CI) of less than 40 ppm, preferably less than 30 ppm and more preferably less than 20 ppm of total weight of the post-consumer recycled polypropylene resin determined by X-Ray Fluorescence (XRF) Spectroscopy.

In one embodiment, the aluminum content is less than 40 ppm, preferably less than 30 ppm and more preferably less than 20 ppm, such as from 0 to 40 ppm, from 0 to 30 ppm or from 0 to 20 ppm, respectively. In another embodiment, the calcium content is less than 40 ppm, preferably less than 30 ppm and more preferably less than 20 ppm, such as from 0 to 40 ppm, from 0 to 30 ppm or from 0 to 20 ppm, respectively. In another embodiment, the chlorine content is less than 40, preferably less than 30 ppm and more preferably less than 20 ppm, such as from 0 to 40 ppm, from 0 to 30 ppm or from 0 to 20 ppm, respectively. In still another embodiment, the content of each of aluminum, calcium and chlorine is less than 40 ppm, preferably less than 30 ppm and more preferably less than 20 ppm, such as from 0 to 40 ppm, from 0 to 30 ppm or from 0 to 20 ppm, respectively. These contents apply to the polymer composition and particularly to the post-consumer recycled polypropylene resin.

### Volatiles and Emissions

Preferably, in the polymer composition, in particular after pelletization, particularly in the post-consumer recycled polypropylene resin thereof, provided by the process according to the present disclosure, the content of compounds having a boiling point below 250° C. is very low, more preferably such compounds are below the limit of detection, when determined by Headspace Gas Chromatography/Mass Spectroscopy (HS-GC-MS) as described herein.

Advantageously, in the polymer composition, in particular after pelletization, particularly in the post-consumer recycled polypropylene resin thereof, the content of each of the compounds, selected from hexanal, limonene, benzene, styrene, and toluene, is below the limit of detection, when determined by Headspace Gas Chromatography/Mass Spectroscopy (HS-GC-MS) as described herein.

### Odor

The polymer composition resulting from the herein disclosed process may be characterized by an odor grade of 3 or lower (analyzed according to VDA270-B3).

### Color

Generally, it is a huge drawback of recycled polymers that they comprise a high content of coloring components that result in a colored or typically greyish appearance of the recycled polymer. Thus, their use is strongly limited to either dark products or products where the appearance is not relevant.

Preferably, the content of coloring components in the polymer composition, particularly in the post-consumer recycled polypropylene resin thereof, provided by the process according to the present disclosure is very low.

Defined by the Commission Internationale de l'Eclairage (CIE), the L*a*b* color space can be used to express coloration of the polymer. It was modeled after a color-opponent theory stating that two colors cannot be red and green at the same time or yellow and blue at the same time. L* indicates lightness, a* is the red/green coordinate, and b* is the yellow/blue coordinate. Deltas for L* (ΔL*), a* (Δa*) and b* (Δb*) may be positive or negative. The total difference, Delta E (ΔE, also Euclidean distance), however, is always positive.

The polymer composition, particularly the post-consumer recycled polypropylene resin thereof, advantageously has an L* value in the CIEL*a*b* color space of at least 75, preferably from 86 to 97, and more preferably from 89 to 97, such as from 90 to 97, determined according to ISO 11664-4.

In some embodiments, the polymer composition has a color difference ΔE of less than 7.5, preferably less than 7.0, such as less than 6 or even less than 5.5, as compared to a reference background, determined according to ISO 11664-4 and using the following equation:

$$Δ E = {( D {L}^{2} + D {a}^{2} + D {b}^{2} )}^{0.5} = {[ {( {L}^{⋆} - {L}_{ref} )}^{2} + {( {a}^{⋆} - {a}_{ref} )}^{2} + {( {b}^{⋆} - {b}_{ref} )}^{2} ]}^{0.5} ,$$

wherein the values of the reference background are: L_{ref}=96.01; a_{ref}=−0.29; b_{ref}=1.79.

In some embodiments, the post-consumer recycled polypropylene resin has a color difference ΔE, as defined above, of less than 6, preferably less than 5.5 and more preferably less than 5.

The color difference indicates color intensity of a component and is defined as the numerical comparison of the component's color to a reference background (here a background plate with L_{ref}=96.01; a_{ref}=−0.29; b_{ref}=1.79). It indicates the differences in absolute color coordinates (CIEL*a*b* color space) and is referred to as Delta (A or D).

In some embodiments, the polymer composition, particularly the post-consumer recycled polypropylene resin thereof, has a CIEL*a*b* color space of
L* from 86 to 97, preferably from 89 to 97, such as from 90 to 97;
a* from −0.5 to 0.0;
b* from 0.0 to 10.0, preferably from 0.0 to 5.0.

In the above embodiments, the color difference ΔE is very low and the compositions appear white. The L* value represents the lightness or brightness of the composition, and a high L* value indicates that the composition is very bright. Accordingly, the respective polymer compositions with a low color difference ΔE and/or high L* value have a white and/or bright appearance, which is comparable to virgin propylene polymers. Thus, they are suitable for use in white or light-color articles, where the appearance is important.

In some embodiments, the polymer composition, particularly the post-consumer recycled polypropylene resin thereof, has a melt flow rate MFR₂ in the range of from 10 to 40 g/10 min, preferably from 12 to 36 g/10 min, more preferably from 15 to 30 g/10 min, determined according to ISO 1133 at 2.16 kg load, 230° C.

### Optical and Mechanical Properties

The polymer composition particularly the post-consumer recycled polypropylene resin thereof, provided by the process according to the present disclosure has a beneficial balance of mechanical properties, in particular break, elongation, and impact properties, and optical properties, in particular good total luminous transmittance.

As such, the polymer composition, particularly the post-consumer recycled polypropylene resin thereof, provided by the process according to the present disclosure is characterized by its good mechanical properties and transmittance.

The polymer composition, particularly the post-consumer recycled polypropylene resin thereof, preferably has a total luminous transmittance measured according to ASTM D1003-13 on compression molded plaques of 60×60×1 mm, in the range of in the range of 60 to 100%, preferably in the range of 65 to 90%, more preferably in the range of 70 to 85%.

In some embodiments, the polymer composition, particularly the post-consumer recycled polypropylene resin thereof, preferably has a tensile modulus E measured according to ISO 527-1/-2 on a compression molded specimen of Tensile type 5A with 2 mm thickness in the range of 1200 to 2000 MPa using a test speed of 20 mm/s, more preferably in the range of 1300 to 1900 MPa, still more preferably in the range of 1400 to 1800 MPa, most preferably in the range of 1500 to 1700 MPa.

In some embodiments, the polymer composition, particularly the post-consumer recycled polypropylene resin thereof, preferably has a Charpy Notched Impact Strength at 23° C. measured according to ISO 179-1/1eA using compression molded specimens of 80×10×4 mm prepared in accordance with EN ISO 19069-2, in the range of 2.0 to 7.0 KJ/m², more preferably in the range of 3.0 to 6.0 KJ/m², still more preferably in the range of 3.2 to 5.0 KJ/m².

Alternatively or additionally, such an overall performance can be expressed by the optomechanical ability:

Optomechanical ability (OMA) is understood as the ratio of mechanical (especially impact and flexural) behavior to optical performance, namely haze, wherein the mechanical properties are targeted to be as high as possible and the optical performance such as haze is desired to be as low as possible. The optomechanical ability can be determined by multiplying Flexural Modulus and notched impact strength and putting this product in relation to haze determined on 1 mm plaques. Such an overall performance can be expressed also by the process focused optomechanical ability: (pOMA).

The optomechanical ability of the polymer composition, particularly the post-consumer recycled polypropylene resin thereof, can be at least 50 or higher, such as 50 to 200.

In some embodiments, the process focused optomechanical ability (pOMA) of the polymer composition, particularly the post-consumer recycled polypropylene resin thereof, can be at least 50 or higher, such as 50 to 200.

The polymer composition comprising a post-consumer recycled polypropylene resin, provided by the process according to the present disclosure has a beneficial balance of further mechanical properties, in particular break, elongation, and impact properties, comparable to virgin polypropylenes.

In some embodiments, the polymer composition, particularly the post-consumer recycled polypropylene resin thereof, has a tensile strength at yield (TSY) of at least 26 MPa, like in the range of 28 to 50 MPa, preferably at least 28 MPa, more preferably at least 30 MPa, measured according to ISO 527-1/-2 as described herein.

In some embodiments, the polymer composition, particularly the post-consumer recycled polypropylene resin thereof, has a flexibility of more than 9, preferably more than 10, such as from 9 to 15 calculated as described herein.

The polymer composition comprising a post-consumer recycled polypropylene resin, provided by the process according to the present disclosure preferably has a beneficial dynamic mechanical properties, in particular a heat detection resistance, comparable to virgin polypropylenes.

In some embodiments, the polymer composition, particularly the post-consumer recycled polypropylene resin thereof, has a heat deflection resistance of at least 97° C., preferably in the range of 97° C. to 110° C., more preferably in the range of 98° C. to 105° C., determined with DMTA as described herein and expressed by the temperature at which the storage modulus E′ of 400 MPa is reached (T(E′=400 MPa)).

In some embodiments, the polymer composition, particularly the post-consumer recycled polypropylene resin thereof, has a storage modulus (E′, 90° C.) in the range of 470 to 600 MPa, preferably in the range of 480 to 550 MPa, measured at 90° C. determined by DMTA as described herein.

In some embodiments, the polymer composition, particularly the post-consumer recycled polypropylene resin thereof, has a storage modulus (E′, 120° C.) in the range of 210 to 350 MPa, preferably in the range of 240 to 300 MPa, measured at 120° C. DMTA as described herein.

The polymer composition may be provided by the process according to the present invention in any of the embodiments as described herein.

### EXAMPLES

### Measurement Methods

The following definitions of terms and determination methods apply to the above general description of the disclosure as well as to the below examples, unless otherwise defined. Unless otherwise indicated, the measurements in the Experimental Section were carried out on the recycled resin after melt-processing, i.e., on the polymer composition.

### Melt Flow Rate

The melt flow rate (MFR) was determined according to ISO 1133 and is indicated in g/10 min. The MFR is an indication of the flowability and hence the processability of the polymer. The higher the melt flow rate, the lower the viscosity of the polymer. Here, the MFR₂ was determined at a temperature of 230° C. and under a load of 2.16 kg.

### Ethylene Content and Triad Distribution of Propylene by ¹³C-NMR

Quantitative nuclear-magnetic resonance (NMR) spectroscopy was used to quantify the ethylene content of the polymers.

Quantitative ¹³C{¹H} NMR spectra were recorded in the solution-state using a Bruker Avance Neo 400 NMR spectrometer operating at 400.15 and 100.62 MHz for ¹H and ¹³C respectively. All spectra were recorded using a ¹³C optimized 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6 k) transients were acquired per spectra.

Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

$$f E = ( E / ( P + E ) )$$

The comonomer fraction was quantified using the method of W-J. Wang and S. Zhu, Macromolecules 2000, 33 1157, through integration of multiple signals across the whole spectral region in the ¹³C{¹H} spectra. Integral regions were slightly adjusted to increase applicability across the whole range of encountered comonomer contents.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

The comonomer sequence distribution at the triad level, meaning the amount of EEE, EEP, PEP, PPP, EPP and EPE, was determined using the method of Kakugo, M., Naito, Y., Mizunuma, K., Miyatake, T. Macromolecules 15 (1982) 1150 through integration of multiple signals across the whole spectral region of the ¹³C{¹H} spectra acquired using defined conditions.

### Crystex Analysis, Crystalline Fraction (CF) and Soluble Fraction (SF)

The crystalline (CF) and soluble fractions (SF) of the PCR polypropylene resins as well as the ethylene contents and intrinsic viscosities of the respective fractions were analyzed by use of the CRYSTEX instrument, Polymer Char (Valencia, Spain) in line with ISO16152-2022—Method 2. Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH₃ stretching vibration (centered at app. 2960 cm⁻¹) and the CH stretching vibration (2700-3000 cm⁻¹) that are serving for the determination of the concentration and the ethylene content in ethylene-propylene copolymers. The IR4 detector is calibrated with series of 8 EP copolymers with known ethylene content in the range of 2 wt % to 69 wt % (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( {CH}_{3} ) \qquad ( equation 1 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2} \qquad ( equation 2 )$$

The constants a to e for equation 1 and a to f for equation 2 were determined by using least square regression analysis.

The CH₃/1000 C is converted to the ethylene content in wt % using following relationship:

$$wt \% ( ethylene in EP copolymers ) = 100 - {CH}_{3} / 1000 TC * 0.3$$

Intrinsic viscosity (IV) of the PCR polypropylene resin and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0.05 mm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N₂ atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV [dl/g] and the C2 [wt %] of the PP composition. During the second injection the soluble fraction (at low temperature) and the crystalline fraction (at high temperature) with the crystallization cycle are measured (wt % SF, wt % CF, wt % C2, wt % C2(SF), wt % C2(CF), IV(SF), IV(CF)), where the wt % CF is calculated in the following way:

$$wt \% CF = 100 - wt \% SF .$$

### Cross Fractionation Chromatography (CFC)

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four band IR5 infrared detector (PolymerChar, Valencia, Spain) was used to monitor the concentration. The polymer was dissolved at 160° C. for 150 minutes at a concentration of around 1 mg/ml.

To avoid injecting possible gels and polymers, which do not dissolve in TCB at 160° C., like PET and PA, the weighed out sample was packed into stainless steel mesh MW 0.077/D 0.05 mm.

Once the sample was completely dissolved an aliquot of 0.5 ml was loaded into the TREF column and stabilized for a while at 110° C. The polymer was crystallized and precipitate to a temperature of 30° C. by applying a constant cooling rate of 0.1° C./min. A discontinuous elution process is performed using the following temperature steps: (35, 40, 50, 55, 60, 65, 70, 75, 80, 85, 90, 95, 100, 103, 106, 109, 112, 115, 117, 119, 121, 123, 125, 127, 130, 135 and 140° C.).

In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PP molecular weight equivalents.

$${K}_{PS} = 19 \times {10}^{- 3} mL / g , {α}_{PS} = 0.655$$

$${K}_{PP} = 19 \times {10}^{- 3} mL / g , {α}_{PP} = 0.725$$

A third order polynomial fit was used to fit the calibration data. Data processing was performed using the software provided from PolymerChar with the CFC instrument.
a) Calculation of the relative fraction at certain molecular weight and elution temperature areas of iso-PP in wt %.

To calculate the relative fraction at certain molecular weight and elution temperature areas of iso-PP in wt % in the first step the amount of iso-PP in wt % from the CFC contour plot needs to be calculated:

$$Iso PP in wt \% = 100 - EPR fraction - PE fraction \qquad equation ( 1 )$$

Where the EPR is the fraction with a molar mass higher than log M of 3.5 of the soluble fraction (SF) in TCB at 35° C. obtained by CFC analysis

$$EPR fraction in wt . - \% = \frac{{\sum }_{j = 3.5}^{8} {H}_{j}}{{\sum }_{j = 2}^{8} {H}_{j}} * SF \qquad equation ( 2 )$$

wherein Hⱼ denotes the signal height and j the log M value.

Due to the slightly dependence of the TREF profile on the low MW part, the molecular weight limit of the low MW limit is elution temperature (Tₑₗ) dependent. The low MW limit was determined using the following formula:

$$Low MW limit ( for PE Fraction ) = 0.0185 * {T}_{el} + 3.1538$$

Taking this into account the PE fraction is calculated using the following approach.

$${PE}_{Fraction} = \frac{{\sum }_{i = 35}^{99} {\sum }_{j = 0.0185 * i + 3.1538}^{8} {H}_{ij}}{{\sum }_{i = 30}^{140} {\sum }_{j = 2}^{8} {H}_{ij}} * 100 \qquad equation ( 3 )$$

Where Hᵢⱼ is the 2D differential distribution at the corresponded elution temperature (Tₑₗ) i and the log M value j, obtained with the corresponded data processing software.

The High crystalline PE fraction (HCF-PE) is defined as the part of the PE fraction eluting from 90° C. to 100° C. of PE fraction.

$$HCF - PE = \frac{{\sum }_{i = 90}^{99} {\sum }_{j = 0.0185 * i + 3.1538}^{8} {H}_{ij}}{{\sum }_{i = 30}^{140} {\sum }_{j = 2}^{8} {H}_{ij}} * 100 \qquad equation ( 4 )$$

wherein Hᵢⱼ denotes the signal height, i the elution temperature and j the log M value.

This fraction contains mainly homo PE and PE copolymers with very low amount of comonomer, below app. 3 SCB/1000 TC (L. Wild, T. R. Ryle, D. C. Knoblauch, I. R. Peat, J. Polym. Sci, Polym. Phys. 20, (1982), 441-455).

Where the low crystalline PE Fraction (LCF-PE) is defined as the part of the PE fraction eluting between 35° C. and 89° C. of the PE fraction.

$$LCF - PE = \frac{{\sum }_{i = 35}^{89} {\sum }_{j = 0.0185 * i + 3.1538}^{8} {H}_{iJ}}{{\sum }_{i = 30}^{140} {\sum }_{j = 2}^{8} {H}_{iJ}} * 100 \qquad equation ( 5 )$$

wherein Hᵢⱼ denotes the signal height, i the elution temperature and j the log M value.

This fraction contains mainly the copolymer fraction from HDPE and LLDPE obtained by ZN catalysts or the LLDPE from SS catalysts but also LDPE, as this kind of polymer are co-eluting due to their comparable amount of SCB/1000 TC.
b) Calculation of Mw(PE) (between 5° and 95° C.) and Mw(SF)

The calculation of Mw(PE) (50-95° C.) is done using the following formula:

$${M}_{w} ( PE ( 50 - 95 ° C . ) = \frac{{\sum }_{i = 50 ° C .}^{95 ° C .} {w}_{i} {M}_{wi}}{{\sum }_{i = 50 ° C .}^{95 ° C .} {w}_{i}} \qquad equation ( 6 )$$

where wᵢ is the weight fraction of TREF fraction at temperature i and M_{wi} is the corresponded weight average molecular weight of the fraction determined by CFC analysis.

Fractions with less than 0.5 wt % are neglected in the calculation.

Where Mw(SF) is the measured Mw value of the 35° C. TREF fraction determined by CFC analysis.
c) Calibration of IR5—detector to determine a number of short-chain branches per 1000 total carbons (SCB/1000 TC) content

The IR5 detector provides different detector signals, which were designated as concentration signal (broad spectral band covering the spectral region from 2800 cm⁻¹ to 3000 cm⁻¹), methyl (CH₃) (narrow band filter centered at 2959 cm⁻¹) and methylene (CH₂) (centered at 2928 cm⁻¹) signal. The ratio of the methyl to the methylene detector signals is correlating to the total amount of methylene (CH₃) per 1000 carbon atoms (CH₃/1000 TC) (A. Ortin, B. Monrabal, J. Montesinos, P. del Hierro, Macromol. Symp. 2009, 282, 65-70). The determination of the CH₃/1000 TC using an IR5 detector can be performed by calibrating the CH₃/CH₂ ratio versus the nominal CH₃/1000 TC content. A linear fit was used for this purpose.

The branching degree of all calibration set samples was determined by ¹³C melt-state NMR as described in K. Klimke, M. Parkinson, C. Piel, W. Kaminsky, H. W. Spiess, M. Wilhelm, Macromol. Chem, and Phys., 2006, 207, 382; M. Parkinson, K. Klimke, H. W. Spiess, M. Wilhelm, Macromol. Chem, and Phys., 2007, 208, 2128. The calibration set used for this method includes 17 different short chain branched polyethylenes, both single site catalysed and fractions of Ziegler Natta catalysed polyethylene-co-butene, polyethylene-co-hexene and polyethylene-co-octene covering an overall branching level up to 80 methyl groups per 1000 carbons (CH₃/1000 C).
d) Calculation of SCB/1000 TC of TREF fraction between 7° and 95° C.

The calculation of SCB/1000 TC content of the TREF fraction (70-95° C.) the following formula is used:

$$SCB / 1000 TC ( 70 - 95 ° C . ) = \frac{{\sum }_{i = 70 ° C .}^{95 ° C .} SCB / 1000 {TC}_{i}}{{\sum }_{i = 50 ° C .}^{95 ° C .} {w}_{i}} \qquad equation ( 7 )$$

where wᵢ is the weight fraction of TREF fraction at temperature i and SCB/1000 TCᵢ is the corresponded short chain branching amount per 1000 total C atoms of the corresponded TREF fraction analyzed by CFC analysis combined with a composition detector. As the majority of the comonomer is ethylene in the polypropylene compound the corresponded C2 content in wt % can be calculated in the following way:

$$The C 2 content ( 70 - 95 ° C . ) = ( 1 - SCB / 1000 TC ( 70 - 95 ° C . ) * 3 / 1000 ) * 100$$

Fractions with less than 0.5 wt % are neglected in the calculation.

### BASIC REFERENCES

Zhang, Macromol Symp. 282 (2009), 111-127.
W. Yau, D. Gillespie, Polymer 42 (2001) 8947-8958.
Monrabal, in “Encyclopedia of Analytical Chemistry”, R. A. Meyers, Ed., John Wiley & Sons Ltd., 2000.
   Nakano, Y. Goto, J. Appl. Polym. Sci. (1981), 26, 4217.
   W. Yau, Macromol. Symp. 2007, 257, 29-45.
   Faldi, J. B. P. Soares, Polymer 42 (2001) 3057-3066.
   Ortin, B. Monrabal, J, Sancho-Tello, Macromol. Symp. 257 (2007), 13-28.
      Amount of “iPP”, “PVC”, “PA”, “PET”, “PS” Determination by Transmission Infrared Spectroscopy

Determination of the components and their amount in the recycled polymer resin is accomplished by FTIR-spectroscopy:

### Sample Preparation:

All calibration samples and samples to be analyzed were prepared in similar way, on molten pressed plates.

Around 2 to 3 g of compounds to be analyzed were molten at 190° C. Subsequently, for 20 seconds 60 to 80 bar pressure was applied in a hydraulic heating press. Next, the samples were cooled down to room temperature in 40 second in a cold press under the same pressure, in order to control the morphology of the compound. The thickness of the plates was controlled by metallic calibrated frame plates 2.5 cm by 2.5 cm, 100 to 200 μm thick (depending on MFR of the sample); two plates were produced in parallel at the same moment and in the same conditions. The thickness of each plate was measured before any FTIR measurements; all plates were between 100 to 200 μm thick.

To control the plate surface and to avoid any interference during the measurement, all plates were pressed between two double-sided silicone release papers.

In case of powder samples or heterogeneous compounds, the pressing process would be repeated three times to increase homogeneity by pressed and cutting the sample in the same conditions as described before.

### Spectrometer:

Standard transmission FTIR spectroscope such as Bruker Vertex 70 FTIR spectrometer was used with the following set-up:
a spectral range of 4000-400 cm⁻¹,
an aperture of 6 mm,
a spectral resolution of 2 cm⁻¹,
with 16 background scans, 16 spectrum scans,
an interferogram zero filling factor of 32
Norton Beer strong apodisation.

Spectra were recorded and analyzed in Bruker Opus software.

### Calibration Samples:

As FTIR is a secondary method, several calibration standards were compounded to cover the targeted analysis range, typically from:
0.2 wt % to 2.5 wt % for Polyamide (PA)
0.1 wt % to 5 wt % for Polystyrene (PS)
0.2 wt % to 2.5 wt % for Polyethylene terephthalate (PET)
0.1 wt % to 4 wt % for Polyvinyl chloride (PVC)

The following commercial materials were used for the compounds: Borealis HC600TF as iPP, Borealis FB3450 as HDPE and for the targeted polymers such RAMAPET N1S (Indorama Polymer) for PET, Ultramid® B36LN (BASF) for Polyamide 6, Styrolution PS 486N (Ineos) for High Impact Polystyrene (HIPS), and for PVC Inovyn PVC 263B (under powder form).

All compounds are made at small scale in a Haake kneader at a temperature below 265° C. and less than 10 minutes to avoid degradation.

Additional antioxidant such as Irgafos 168 (3000 ppm) is added to minimize the degradation.

### Calibration:

The FTIR calibration principal is the same for all the components: the intensity of a specific FTIR band divided by the plate thickness is correlated to the amount of component determined by ¹H or ¹³C solution state NMR on the same plate.

Each specific FTIR absorption band is chosen due to its intensity increase with the amount of the component concentration and due to its isolation from the rest of the peaks, whatever the composition of the calibration standard and real samples.

This methodology is described in the publication from Signoret and al. “Alterations of plastic spectra in MIR and the potential impacts on identification towards recycling”, Resources, conservation and Recycling journal, 2020, volume 161, article 104980.

The wavelength for each calibration band is:
3300 cm⁻¹ for PA,
1601 cm⁻¹ for PS,
1410 cm⁻¹ for PET,
615 cm⁻¹ for PVC,
1167 cm⁻¹ for iPP.

For each polymer component i, a linear calibration (based on linearity of Beer-Lambert law) is constructed. A typical linear correlation used for such calibrations is given below:

$${x}_{i} = {A}_{i} \cdot \frac{{E}_{i}}{d} + {B}_{i}$$

where
xᵢ is the fraction amount of the polymer component i (in wt %);
Eᵢ is the absorbance intensity of the specific band related to the polymer component i (in a.u. absorbance unit). These specific bands are, 3300 cm⁻¹ for PA, 1601 cm⁻¹ for PS, 1410 cm⁻¹ for PET, 615 cm⁻¹ for PVC, 1167 cm⁻¹ for iPP;
d is the thickness of the sample plate;
Aᵢ and Bᵢ are two coefficients of correlation determined for each calibration curve.

For each calibration standard, wherever available, the amount of each component is determined by either ¹H or ¹³C solution state NMR, as primary method (except for PA).

The NMR measurements are performed on the exact same FTIR plates used for the construction of the FTIR calibration curves.

### Ash Content

Thermogravimetric Analysis (TGA) experiments were performed with a Perkin Elmer TGA 8000 in line with ISO 11358-1 (2014). Accordingly, approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the wt % at 850° C., based on the total weight of the used starting material. As a reference, the ash content was also measured by an oven method according to ISO 3451-1 (1997), wherein comparable results were obtained.

### Content of Metals and Chlorine

The metal and chlorine content were determined by X-ray Fluorescence (XRF) Spectroscopy. The instrument used for the XRF measurements was a wavelength dispersive device called Zetium (2.4 kW) from Malvern Panalytical. The instrument was calibrated with polyolefin based standard sets from Malvern Panalytical. The method is used to determine the quantitative content of F, Na, Mg, Al, Si, P, S, Ca, Ti, Zn, Cr, Cd, Hg, Pb, As, Ni, Cu, Ba, Br, CI, Sb, Sn in polyolefin matrix within defined ranges of these standards. The analyses are done under vacuum on a plaque with a diameter of 40 mm and a thickness of 2 mm.

### CIEL*a*b* Color Space Values and Color Difference Analysis

Color values and color difference were determined according to ISO 11664-4.

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A was used for measurement.

Around 20 g of cryomilled PP powder was placed into a sampling cuvette avoiding any voids prior measurements.

Color of the IE and CE samples and color of the reference background (here a background plate with L_{ref}=96.01; a_{ref}=−0.29; b_{ref}=1.79) were measured and the values for each measurement were saved. The color differences (the Euclidean distance ΔE) between the sample and a reference background were calculated using the resulting colorimetric values and the following equation:

$$Δ E = {( D {L}^{2} + D {a}^{2} + D {b}^{2} )}^{0 .. 5} = {[ {( {L}^{⋆} - {L}_{ref} )}^{2} + ( {a}^{⋆} - {a}_{{ref )}^{2}} + {( {b}^{⋆} - {b}_{ref} )}^{2} ]}^{0.5} .$$

### Headspace Gas Chromatography/Mass Spectroscopy (HS-GC-MS)

The determination of selected marker substances is based on a static headspace (HS) approach. This analysis uses a combination of a HS sampler with a gas chromatograph (GC) and a mass spectrometer (MS) for screening purposes.

Samples were delivered to the lab in sealed aluminum-coated polyethylene (PE) bags. Prior to the analysis, samples were cryo-milled, a portion of 2.000±0.100 g was weighed in a 20 ml HS vial and tightly closed. For every sample, a double determination was performed.

### HS/GC/MS Parameters

HS parameters (Agilent G1888 Headspace Sampler)
   Vial equilibration time: 120 min (sample), 5 min (standard)
   Oven temperature: 100° C. (sample), 200° C. (standard)
   Loop temperature: 110° C. (sample), 205° C. (standard)
   Transfer line temperature: 120° C. (sample), 210° C. (standard)
   Low shaking
GC parameters (Agilent 7890A GC System)
   Column: ZB-WAX 7HG-G007-22
   (30 m×250 μm×1 μm)
   Carrier gas: Helium 5.0
   Flow: 2 ml/min
   Split: 10:1
   GC oven program: 35° C. for 0.1 min
      10° C./min until 250° C.
      250° C. for 1 min
MS parameters (Agilent 5975C inert XL MSD)
   Acquisition mode: Scan
   Scan parameters:
      Low mass: 20
      High mass: 200
      Threshold: 10
Software/Data evaluation
   MSD ChemStation E.02.02.1431
   MassHunter GC/MS Acquisition B.07.05.2479
   AMDIS GC/MS Analysis Version 2.71
   NIST/EPA/NIH Mass Spectral Library (2011 version)
   NIST Mass Spectral Search Program Version 2.0 g
AMDIS deconvolution parameters
   Minimum match factor: 80
   Threshold: Low
   Scan direction: High to Low
   Data file format: Agilent files
   Instrument type: Quadrupole
   Component width: 20
   Adjacent peak subtraction: Two
   Resolution: High
   Sensitivity: Very high
   Shape requirements: Medium
   Solvent tailing: 44 m/z
   Column bleed: 207 m/z
   Min. model peaks: 2
   Min. S/N: 10
   Min. certain peaks: 0.5
MSD ChemStation integration parameters
   Integrator: ChemStation
   Initial area reject: 0
   Initial peak width: 0.005 (for limonene and acetaldehyde) 0.200 (for acetic acid)
   Shoulder detection: off
   Initial threshold: 8.0 (for limonene and acetaldehyde) 10.5 (for acetic acid)

In this study, the statement “below the limit of detection (<LOD)” describes a condition where either the peak as such is not even recognized or the match factor is below 80 (AMDIS) or the signal to noise ratio (Pk-pk S/N=Corrected signal/Pk-pk noise, MSD ChemStation signal to noise report) of the peak in the sample run is below 3. The results refer solely to the measured samples, time of measurement and the applied parameters.

### Standard Solutions

For a positive identification and comparison with the (lowest) odor detection thresholds (ODT), standards with the defined marker substances were created (see Table). For standard 1 methanol was used as a solvent and for standard 2 2-butanol.

For the HS/GC/MS analysis, 5 μl of each standard were injected in a separate 20 ml HS vial, tightly closed and measured.

Assuming full vaporization of all standard substances, the concentration of each analyte in the HS c_{G} was estimated as listed in Table A.

TABLE A
Calibration standards and ODTs

| | | c_{G}/ng | Target ion | (lowest) ODT/mg |
|---|---|---|---|---|
| Analyte | Standard | ml⁻¹ | (m/z) | m⁻³ [1] |
| Acetic acid | Standard 1 | 98 | 60 | 0.001 |
| Limonene | Standard 1 | 32 | 68 | 0.21 |
| Acetaldehyde | Standard 2 | 71 | 44 | 0.0027 |

### Data Evaluation

The concentration of an analyte in the HS c_{G} is calculated by considering the substance amount m_{G} and the available HS volume V_{G}.

$${c}_{G}^{Standard} = \frac{{m}_{G}^{Standard}}{{V}_{G}^{S t a n d a r d}}$$

By integrating the extracted ion chromatogram (EIC), the peak area is obtained for every analyte. The corresponding target ions are listed in Table A. The theoretical peak area of the (lowest) ODT is reflected by:

$$Theoretical peak {area}^{ODT} = \frac{Peak {area}^{Standard}}{{c}_{G}^{Standard}} * ODT$$

To estimate the odor relevance of an analyte in the HS above a polymer sample, the peak area of an analyte (sample) is compared with the theoretical peak area (ODT).

Additionally, an odor activity factor was introduced. This factor is the fraction of the actual peak area of the analyte (sample) and the theoretical peak area at the lowest ODT found in literature [1]. A value above 1 indicates the relevance of an analyte to the odor at the given HS temperature.

$$Odor activity factor = \frac{Peak {area}^{Sample}}{Theoretical peak {area}^{ODT}}$$

Odor VDA270-B3 The VDA 270 is intended for the determination of the odor characteristics of trim materials in motor vehicles and on parts in contact with the air introduced into the vehicle interior.

For this sensory test a trained and selected panel of odor assessors is required. Typically, 3 testers are used. In case individual results differ by more than 2 points in one test or in case of approval tests at least 5 testers are required as well as a double determination. The room, in which the sensory tests are performed is free of any disturbing odors. Furthermore, assessors are not allowed to bias each other by strong odors like cigarette smoke, perfume, food odors or similar.

The sample comes sealed in aluminum-coated polyethylene bags. After arrival in the lab it is openly stored for one week at 23° C. (+/−2° C.) and protected from direct sun light and cross-contamination. For each assessor 20 g (+/−2 g) of sample are weighed in a 1 liter jar which is tightly closed immediately after weighing in.

The jars are heated to 80° C. (+/−2° C.) for 2 h (+/−10 min). After that the jars are allowed to cool down to 60° C. (+/−5° C.) before the sensory panel is told to start the odor assessment.

The odor of the respective sample is evaluated by each assessor according to the VDA 270 scale after lifting the jar's lid as little as possible.

The hexamerous scale consists of the following grades:
Grade 1: not perceptible,
Grade 2: perceptible, not disturbing,
Grade 3: clearly perceptible, but not disturbing,
Grade 4: disturbing,
Grade 5: strongly disturbing,
Grade 6: not acceptable.

Assessors stay calm during the assessment and are not allowed to bias each other by discussing individual results during the test. They are not allowed to adjust their assessment after testing another sample, either.

For statistical reasons (and as accepted by the VDA 270) assessors are forced to use whole steps in their evaluation. Consequently, the odor grade is based on the average mean of all individual assessments, and rounded to whole numbers.

### Charpy Notched Impact Strength (NIS)

Notched Charpy impact strength was determined at 23° C. according to ISO 179-1/1eA. 4-mm thick compression molded specimens, from pellets, were prepared in accordance with EN ISO 19069-2. The plaques were then milled into 80*10*4 mm (type B) specimens. The notch tip has a radius 0.25 mm and the span used is 62 mm for testing. 9-10 specimens were tested and the average value is reported.

### Optical Properties

Haze and total luminous transmittance were measured according to ASTM D1003-13. (Method A-Hazemeter)

Gloss is measured at 20°, 60° and 85° according to ISO 2813.

The materials were compression molded following into 1 mm thick plaques which are then die cut to 60×60×1 mm specimens for testing in line with EN ISO 19069-2 with ISO D1 mold.

Optomechanical Ability (OMA) and Process Focused Optomechanical Ability (pOMA)

The optomechanical ability is determined according the formula given below:

$$OMA = \frac{Tensile Modulus [ MPa ] * NIS [ \frac{k J}{{m}^{2}} ]}{Haze ( 1 mm ) [ \% ]}$$

Accordingly, the process focused optomechanical ability: pOMA can be determined as given in formula below:

$$pOMA = \frac{Tensile Modulus * ( NIS + \frac{MFR}{100} )}{Haze ( 1 mm )}$$

### Determination of Dynamic Mechanical Properties-Tensile Stressed

In a dynamic mechanical thermal analysis (DMTA) in tensile mode the sample is subjected to a constant load together with an applied sinusoidal tensile strain. Under low enough deformation material response is kept within the linear viscoelastic region which is independent of strain amplitude.

The tensile storage modulus E′ (1) and the tensile loss modulus E″ (2) are determined from the following equations

$${E}^{′} = \frac{Δ {F}_{A}}{{s}_{A}} * \frac{{L}_{a}}{b d} * cos δ [ Pa ] \qquad ( 1 )$$

$${E}^{″} = \frac{Δ {F}_{A}}{{s}_{A}} * \frac{{L}_{a}}{b d} * sin δ [ Pa ] \qquad ( 2 )$$

where
ΔF_{A} is the measured amplitude of dynamic force, in newton
s_{A} is the measured amplitude of the dynamic displacement, in meters
Lₐ is the distance between the clamps, in meters
b is the width of the specimen, in meters
d is the thickness of the specimen, in meters
δ is the measured phase angle, in degrees.

The determination of the so-called damping factor is done as described in following equation.

$$tan δ = \frac{{E}^{″}}{{E}^{′}} \qquad [ 1 ]$$

The characterization of dynamic-mechanic properties complies with ISO standards 6721-1, 6721-4, 6721-11. The measurements were performed on a “Netzsch DMA 242E Artemis” strain/stress-controlled dynamic mechanical Analyzer, equipped with a tensional-sample holder for rectangular specimen geometry. Measurements were undertaken on rectangular sample cut from compression molded plates produced with a “Collin 400P/M” thermo-press, using 200° C. and an annealing time of 300 seconds for melting at a pressure of 5 bar, then a compression pressure of 25 bar was used for 300 seconds and a pressure of 50 bar for cooling down to room-temperature using a cooling rate of 15 K/min. The compression molded plate with a geometry of 100×100× 0.1 mm was prepared and stored for a minimal rest time of 96 hours after compression molding. The rectangular sample prepared using a laboratory cutter to ensure a geometry of length×width×thickness of 20 mm×4 mm×0.1 mm for clamping the specimen. The free tensile-length was about 12 mm measured with a calliper at room temperature with an accuracy of 0.05 mm. The width and the thickness were measured using a suitable length gauge with an accuracy of 0.001 mm. The dynamic mechanic thermal analysis was performed under inert atmosphere using liquid nitrogen for cooling within the temperature range of −80° C. to +150° C. with a heating rate of 2 K/min, a frequency of 1 Hz, in strain-stress controlled mode with a maximum dynamic applied stress of 7.0 MPa, a static load of 0.20 MPa and a maximum strain of 0.20%. The clamping of the specimens were performed using a torque of 2.5 cNm on screws. The conditioning at the start-temperature of −80° C. was carried out with an isothermal section of 15 minutes. The evaluation was performed using the software “Proteus Thermal Analysis—Version 6.1.0” to read up E′ at 90° C., 120° C. and the temperature of E′ is 400 MPa. Furthermore, the temperature of peaks on tan δ—(glass transition T_{g}) and E″-functions are determined. between −80° C. and 160° C. using a heating rate of 2K/min and a frequency of 1 Hz.

The Tg (glass transition temperature) was determined from the curve of the loss angle (tan (δ)).

### REFERENCES

[1] “Dynamic mechanical analysis: a practical introduction” Kevin P. Menard © 2008 by Taylor & Francis Group, LLC, Dynamic Testing and Instrumentation, 71-76, 2008

### Tensile Properties

The tensile properties, tensile modulus (E), elongation at yield (EAY), and tensile strength at yield (TSY) were measured at 23° C. and after 96 h of conditioning time, according to ISO 527-1/-2, samples are compression molded into 5A tensile specimens with 2 mm thickness, in line with EN ISO 19069-2, with the following conditions:

Preload: 1 N; Speed preload: 0.5 mm/min; Test speed modulus: 0.5 mm/min; Test speed: 20.0 mm/min; Ex for determination of σs: 100%; Gripping distance: 50 mm; Gauge length: 20 mm; Modulus: Secant method, Start_modulus: 0.05%; End_modulus 0.25%.

### Flexibility

The Flexibility value is calculated according to the equation below:

$$Flexibility = EAY * 100000 TSY * E$$

Wherein: EAY is the elongation at yield value in %, TSY is the tensile strength at yield value in MPa E is the tensile modulus value, in MPa, and wherein EAY, TSY, and E are determined at 23° C. according to ISO 527.

### Wide-Angle X-Ray Scattering (WAXS)

The degree of crystallinity of the iPP samples was studied by carrying out WAXS measurements in reflection mode with a Bruker Discover D8 diffractometer equipped with a two-dimensional GADDS detector and a Ni-filtered CuKα X-rays. Three measurements were performed on each sample and the corresponding results were averaged. The amorphous halo obtained from an atactic-PP sample (D. Tranchida, L. Resconi L., Influence of 2, 1-erythro regiodefects on the crystallization behavior of isotactic polypropylene, Polymer Crystallization 1 (2018) e10022) was properly scaled and subtracted and a crystallinity index (Xc) was quantified according to:

$${X}_{C} = \frac{{A}_{C}}{{A}_{t o t}}$$

where Aₜₒₜ is the area under the total pattern and A_{c} is the area after subtraction of the amorphous halo.

Also, the relative content of the β-modification was calculated from the intensities of specific reflections after subtraction of the amorphous halo according to Turner-Jones et al. (A. T. Jones, J. M. Aizlewood, D. Beckett, Crystalline forms of isotactic polypropylene, Makromol. Chem.: Macromol. Chem. Phys. 75 (1964) 134-158):

$${K}_{β} = \frac{I β ( 300 )}{I α ( 110 ) + I α ( 040 ) + I α ( 130 ) + I β ( 300 )}$$

where the γ-modification was calculated from the intensities of specific reflections after subtraction of the amorphous halo using the method developed by Pae (Pae K D, J. Polym. Sci., Part A, γ-α Solid-solid transition of isotactic polypropylene, 6, (1968) 657-663):

$${K}_{γ} = \frac{I γ ( 117 )}{I γ ( 130 ) + I γ ( 117 )}$$

### Experimental

Two inventive examples (IE1 and IE2) and several comparative examples (“CE”) were prepared.

CE1, CE2, CE3, CE5 and CE8 were produced with post-consumer packaging waste as the feedstock material. Among them, the feedstock of CE1 contains mainly the flexible polyolefin items such as films, carrier bags, etc.; whereas the feedstock of CE2, CE3, CE5 and CE8 contains mainly rigid PP items such as bottles, cups and trays, etc. CE1, CE2, CE3, CE5 and CE8 were obtained by a recycling process comprising the following steps:
sieving the plastic feedstock to create sieved plastic waste material having only articles with a longest dimension up to 400 mm;
sorting out goods made from polystyrene, polyamide, polyethylene, metals, paper, and wood from the feedstock thereby providing a post-consumer plastic material; CE1, CE2 and CE5 were obtained as the light color fractions by color sorting by sorting out natural (for example CE5) and white products (for example CE2) and light color fractions (for example CE1) and the non-out-sorted material remained as a post-consumer mixed color polypropylene recycling material with defined color mix (for example CE3A and CE3B);
subjecting the selected post-consumer plastic material with the defined color to wet-grinding to form flaked post-consumer plastic material in flake form with a longest dimension of up to 20 mm, washing in an aqueous solution with the aid of thermal energy to reach a temperature in the range of from 35 to 95° C. and applying a residence time in the range of from 1 to 20 minutes with various detergents under alkaline conditions through the addition of NaOH in a concentration of 1.5-2 wt % and subsequently drying to reach a final water content of below 2 wt %, windsifting and screening to separate specific polymeric material other than the polypropylene to be recycled, as well as to narrow down the population of flakes to the optimal range of size for optical sorting, by sieving out the fraction <2.5 mm; subjecting the thus obtained pretreated post-consumer plastic material to a further sorting for eliminating non-polyolefin and specified colored parts yielding a purified polypropylene polyolefin recycling stream; and melt-extruding and melt-filtering, applying a melt screen size in the range of from 90 and 110 μm, the material and yielding the polypropylene blend in the form of pellets as an extruded, pelletized, recycled polypropylene product.

CE3A and CE3B were prepared from different feedstock lots.

The extruded, pelletized, recycled polypropylene products CE1, CE2, CE3A, CE3B, CE5 and CE8 all had a polypropylene content of around 95 wt % (see Table 1 below). 1500 ppm Irganox 1010 and 1500 ppm Irgafos 168 were also added during extrusion to each of the comparative samples CE1, CE2, CE3A, CE3B, CE5 and CE8.

These mechanically recycled polypropylene products can be further treated in a solvent-based-recycling process as described herein.
CE5B is a “high purity” reference from mechanical recycling after drying the polymer pellets for 4 h at 120° C. prepared from CE5.
CE4 is commercial heterophasic propylene copolymer composition “BE170CF” obtained from Borealis AG, Austria.
CE6 is commercial random propylene copolymer composition “RD204CF” obtained from Borealis AG, Austria.
CE7 is commercial random propylene copolymer composition “RD734MO” obtained from Borealis AG, Austria.

The inventive example IE1 was prepared from the mechanically recycled CE3A (in flake form) and the inventive example IE2 from the mechanically recycled CE3B (in flake form) by the same solvent-based recycling process.

### Inventive Example 1

A pre-purified feedstock (CE3A) comprising 95% by weight of polypropylene (PP) was introduced in flake form into an extruder which was heated to 200° C. At the outlet of the extruder, the feedstock was at least partly in melt form (i.e., at least substantially all polyolefinic material was in melted form) and was mixed with n-heptane pre-heated at 200° C., with a weight ratio solvent:feedstock of 5:1. The mixture comprising the solvent and the feedstock was introduced into a stirred reactor which is heated to 200° C., and was maintained at 2.0 MPa abs, for a residence time of 1 hour. A polymer solution with high homogeneity is thus obtained.

The polymer solution is continuously drawn off from the stirred reactor and introduced in a static settler. The settling is operated at 200° C. and 2.0 MPa.

A cleared polymer solution was continuously drawn off from the settler and passes through two filters in series, maintained at 200° C. and having cut diameter equal to 10 μm and 1 μm, respectively (in this order).

At the outlet of the filter's series, the pre-purified polymer solution was then passed through an adsorption section which comprises a charcoal particles bed. This adsorption step was carried out at 200° C. and 2.0 MPa and such that the weight content of charcoal particles represents 6.3% by weight of the pre-purified polymer solution weight.

The purified solution at the outlet of the adsorption section was then submitted to solvent-polymer separation by vaporizing n-heptane, to obtain a post-consumer recycled polypropylene resin that was further prepared to the composition IE1 by the extrusion as described below. Solvent-polymer separation was performed in a flash devolatilization section operated at an inlet temperature of 180° C. and a pressure of 0.14 MPa.

### Inventive Example 2

A pre-purified feedstock (CE3B) comprising 95% by weight polypropylene (PP) was introduced in flake form into an extruder which was heated at 200° C. At the outlet of the extruder, the feedstock was at least partly in melt form (i.e. at least substantially all polyolefinic material was in melted form) and was mixed with n-heptane pre-heated at 200° C., with a weight ratio solvent:feedstock of 5:1. The mixture comprising the solvent and the feedstock was introduced into a stirred reactor which is heated at 200° C., and was maintained at 2.0 MPa abs, for a residence time of 1 hour. A polymer solution is thus obtained.

The polymer solution is continuously drawn off from the stirred reactor and introduced in a static settler. The settling is operated at 200° C. and 2.0 MPa.

A cleared polymer solution was continuously drawn off from the settler and passed through two filters in series, maintained at 200° C. and having cut diameter equal to 10 μm and 1 μm (in this order), respectively.

At the outlet of the filter's series, the pre-purified polymer solution was then passed through an adsorption section which comprises a charcoal particles bed. This adsorption step was carried out at 200° C. and 2.0 MPa and such that the weight content of charcoal particles represents 3.2% by weight of the pre-purified polymer solution weight.

The purified solution at the outlet of the adsorption section was then submitted to solvent-polymer separation by vaporizing n-heptane, to obtain a post-consumer recycled polypropylene resin that was further prepared to the composition IE2 by the extrusion as described below. Solvent-polymer separation was performed in a flash devolatilization section operated at an inlet temperature of 180° C. and a pressure of 0.14 MPa.

To mimic the solvent removal efficiency of a devolatilization and/or degassing extruder both IE1 and IE2 were cryomilled to powder and dried over night for about 16 h at 90° C. using vacuum of about 10 mbar abs (1 kPa abs). Pellets were produced from the cryomilled and dried polymer powder with a small scale extruder due to the low amount of cryomilled powder. The small scale extruder is a 16 mm screw diameter machine without degassing option. The extruder was run with 200 rpm and a throughput of 1 kg/h. 1500 ppm each of stabilizers Irganox 1010 and Irgafos 168 were added. Thus, the 5 pellets of IE1 and IE2 (melt-processed polymer composition) contained at least 99 wt % of post-consumer recycled polypropylene resin and about 0.3 wt % additives, based on the total weight of the polymer composition. The pelletized samples were analyzed without any further agitation or devolatization step. Properties of the PCR polypropylene samples are indicated in Table 1 below.

TABLE 1
General properties of the comparative and inventive examples.

| | | | | CE1 | | CE3A | CE3B | | | |
|---|---|---|---|---|---|---|---|---|---|---|
| | | | IE2 | PP | CE2 | PP | PP | | CE5 | CE8 |
| | IE1 | | SBR - | flex | PP | rigid | rigid | CE4 | PP | PP |
| | SBR - based | | based | (light | rigid | (mixed | (mixed | Virgin | rigid | rigid |
| Material/ | PP | | PP | color) | (white) | color) | color) | PP | natural | natural |
| Parameter | powder | | pellets | | | | | | | |
| C7 content | ~1000* | n.m. | n.m. | n.m. | n.m. | n.m. | n.m. | n.m. | n.m. | n.m. |
| before | | | | | | | | | | |
| drying (ppm) | | | | | | | | | | |
| C7 content | <10* | n.m. | n.m. | n.m. | n.m. | n.m. | n.m. | n.m. | n.m. | n.m. |
| after drying | | | | | | | | | | |
| (ppm) | | | | | | | | | | |
| MFR | 18* | 19 | 35 | 10 | n.m. | 16 | 26 | 13 | 12 | 14 |
| (g/10 min, | | | | | | | | | | |
| 230° C./ | | | | | | | | | | |
| 2.16 kg) | | | | | | | | | | |
| PA | n.d | n.d. | n.d. | 0.2 | n.d. | n.d. | n.d. | n.m. | n.m. | n.d. |
| (wt %, FTIR) | | | | | | | | | | |
| PS | n.d. | n.d. | n.d. | n.d. | n.d. | n.d. | 0.1 | n.m. | n.m. | n.d. |
| (wt %, FTIR) | | | | | | | | | | |
| PET | n.d. | n.d. | n.d. | n.d. | n.d. | n.d. | n.d. | n.m. | n.m. | n.d. |
| (wt %, FTIR) | | | | | | | | | | |
| PVC | n.d | n.d. | n.d. | n.d. | n.d. | n.d. | n.d. | n.m. | n.m. | n.d. |
| (wt %, FTIR) | | | | | | | | | | |
| iPP content | 95.4* | 95.4 | 96.4 | 94.5 | 93.2 | 94 | 93.7 | n.m. | n.m. | 96 |
| (wt % FTIR) | | | | | | | | | | |
| C2 content | 3.3* | n.m. | 3.6 | 5.7 | 5.3 | 7 | 5.6 | 8.7 | n.m. | n.m. |
| (wt % NMR) | | | | | | | | | | |
| C2 (wt %, | 3.5* | 3.5 | 3.3 | 5.2 | 5.9 | 7.7 | 5.4 | 7.5 | n.m. | 4.2 |
| Crystex) | | | | | | | | | | |
| C2(CF) | 1.5* | 2.1 | 1.3 | 4.5 | 3.2 | 6.2 | 3.2 | 1.5 | n.m. | 3.8 |
| (wt %, | | | | | | | | | | |
| Crystex) | | | | | | | | | | |
| C2(SF) | 24.1* | 21.7 | 23.7 | 16.1 | 27.1 | 26.2 | 27.7 | 39.1 | n.m. | 17.7 |
| (wt %, | | | | | | | | | | |
| Crystex) | | | | | | | | | | |
| SF (wt %, | 8.7* | 8.6 | 10.6 | 7.8 | 10.6 | 9.4 | 11.1 | 16.3 | n.m. | 7.1 |
| Crystex) | | | | | | | | | | |
| CF (wt %, | 91.3* | 91.4 | 89.4 | 92.2 | 89.4 | 90.6 | 88.9 | 83.7 | n.m. | 92.9 |
| Crystex) | | | | | | | | | | |
| IV (SF) | 1.4* | 1.5 | 1.5 | 1.3 | 1.4 | 1.7 | 1.7 | 2.5 | n.m. | 1.0 |
| (dl/g, | | | | | | | | | | |
| Crystex) | | | | | | | | | | |
| PE (HCF) | 0.3* | 0.3 | 0.4 | 0.4 | 0.5 | 1.8 | 1.0 | 0.7 | n.m. | n.m. |
| (wt %, CFC) | | | | | | | | | | |
| PE (LCF) | 2.8* | 2.7 | 2.2 | 4.8 | 3.6 | 4 | 3.5 | 2.4 | n.m. | n.m. |
| (wt %, | | | | | | | | | | |
| CFC) | | | | | | | | | | |
| EPR (wt %, | 7.1* | 7.1 | 8.7 | 5.5 | 8.4 | 7.4 | 9.6 | 15.9 | n.m. | n.m. |
| CFC) | | | | | | | | | | |
| Mw(SF) | 138* | 130 | 132 | 109 | 130 | 147 | 170 | 192 | n.m. | n.m. |
| (kg/mol) | | | | | | | | | | |
| Mw(PE) | 59* | 54 | 42 | 85 | 137 | 102 | 148 | 115 | n.m. | n.m. |
| (kg/mol, | | | | | | | | | | |
| 50-95° C.) | | | | | | | | | | |
| Mw(SF)/ | 2.3* | 2.4 | 3.1 | 1.3 | 1.0 | 1.4 | 1.1 | 1.7 | n.m. | n.m. |
| Mw(PE) | | | | | | | | | | |
| SCB/1000 | 304* | 301 | 317 | 212 | 271 | 207 | 230 | 175 | n.m. | n.m. |
| TC | | | | | | | | | | |
| CFC (70- | | | | | | | | | | |
| 95° C.) | | | | | | | | | | |
| C2 (wt %) | 8.5* | 9.7 | 4.9 | 36.4 | 18.7 | 37.9 | 31.1 | 47.5 | n.m. | n.m. |
| CFC (70- | | | | | | | | | | |
| 95° C.) | | | | | | | | | | |

*measured on powder sample prior to melt-processing (i.e., extrusion)

The following abbreviations are used in all Tables herein:
n.d.=not determinable, i.e. lower than limit of detection and/or lower than limit of quantification;
n.m.=not measured
LOQ=limit of quantification
LOD=limit of detection

From Table 1, can be seen the general properties of the inventive examples (IE1, IE2) when compared to other recycled polypropylene samples (i.e., CE1 to CE3) and virgin polypropylene (CE4).

TABLE 2
Contaminants in the comparative and inventive examples.

| | | | | CE1 | | CE3A | CE3B | | | |
|---|---|---|---|---|---|---|---|---|---|---|
| | | | IE2 | PP | CE2 | PP | PP | | CE5 | CE8 |
| | IE1 | | SBR - | flex | PP | rigid | rigid | CE4 | PP | PP |
| | SBR - based | | based | (light | rigid | (mixed | (mixed | Virgin | rigid | rigid |
| Material/ | PP | | PP | color) | (white) | color) | color) | PP | natural | natural |
| Parameter | powder | | pellets | | | | | | | |
| Ash content | 0.02* | 0.02 | 0.00 | 0.6 | 1.5 | 1.0 | 1.14 | 0.03 | 0.10 | 0.07 |
| (wt %, ISO | | | | | | | | | | |
| 3451-1) | | | | | | | | | | |
| Ash content | 0.00* | 0.00 | 0.00 | 0.65 | n.m. | 1.0 | 1.21 | n.m. | n.m. | 0.00 |
| (wt %, TGA) | | | | | | | | | | |
| Ti (ppm, | <5 (LOQ)* | 6 | 6 | 1944 | 5828 | 4090 | 2833 | <2 (LOD) | n.m. | 30 |
| XRF) | | | | | | | | | | |
| Al (ppm, | 16* | <8 (LOQ) | <8 (LOQ) | 130 | 136 | 116 | 215 | 45 | n.m. | 57 |
| XRF) | | | | | | | | | | |
| Ca (ppm, | 11* | 12 | 12 | 1109 | 1487 | 1359 | 1957 | 24 | n.m. | 88 |
| XRF) | | | | | | | | | | |
| Cl (ppm, | 13* | 17 | 17 | 306 | 71 | 44 | 103 | 20 | n.m. | 36 |
| XRF) | | | | | | | | | | |
| Heavy metal | n.d.* | n.d. | n.d. | n.d. | n.d. | 19 | 17 | n.d. | n.m. | n.d. |
| (ppm, XRF, | | | | | | | | | | |
| sum of Cd, | | | | | | | | | | |
| Cr, Hg, Pb) | | | | | | | | | | |

*measured on powder sample prior to melt-processing (i.e., extrusion)

From Table 2, it can be seen that the contaminant content is highly decreased in the inventive examples (IE1, IE2) when compared to other recycled polypropylene samples (i.e., CE1 to CE3). Some contaminants are present in lower contents than in virgin polypropylene (i.e., CE4).

TABLE 3
Emission properties of the comparative and inventive examples.

| | | | | IE2 | | | CE5B |
|---|---|---|---|---|---|---|---|
| | | IE1 | | SBR - | CE3A | CE3B | PP |
| | | SBR - based PP | | based PP | PP mix | PP mix | natural |
| Compound | Units | powder | pellets | | | | |
| Toluene | μg/m³ | <0.08 | <0.08 | <0.05 | <0.06 (LOD) | <0.10 (LOD) | <0.06 (LOD) |
| | | (LOD)* | (LOD) | (LOD) | | | |
| Hexanal | μg/m³ | <3.49 | <3.49 | <4.31 | 8.91 | 11.5 | 11.4 |
| | | (LOD)* | (LOD) | (LOD) | | | |
| Limonene | μg/m³ | <0.32 | <0.32 | <0.39 | 8.4 | 42.8 | 10 |
| | | (LOD)* | (LOD) | (LOD) | | | |
| Benzene | μg/m³ | <0.06 | <0.06 | <0.08 | <0.07 (LOD) | <0.08 (LOD) | <0.08 (LOD) |
| | | (LOD)* | (LOD) | (LOD) | | | |
| Styrene | μg/m³ | <0.08 | <0.08 | <0.05 | <0.05 (LOD) | 0.8 | <0.07 (LOD) |
| | | (LOD)* | (LOD) | (LOD) | | | |
| Odor | | 3* | 3 | 3 | 3 | n.m. | n.m. |
| (VDA 270) | | | | | | (too high | |
| | | | | | | emission | |
| | | | | | | for | |
| | | | | | | testing) | |

*measured on powder sample prior to melt-processing (i.e., extrusion)

The LOD was estimated using a signal to noise threshold of 3 and multiplying this with the concentration of the standard divided by the signal to noise level of the analysis of 5 the corresponded standard.

$$LOD = \frac{threshold * concentration}{signal to noise}$$

From Table 3, it can be seen that the emissions are highly reduced in the inventive examples (IE1, IE2) both as resin powder and in pelletized melt-treated form when compared to other recycled polypropylene samples (CE3A, CE3B, CE5B).

TABLE 4
Color properties of the comparative and inventive examples.

| | | | IE2 | CE2 | CE3A | CE5 |
|---|---|---|---|---|---|---|
| | | | SBR - | PP | PP rigid | PP |
| | IE1 | | based | rigid | (mixed | (natural |
| Material/ | SBR - based PP | | PP | (white) | color) | color) |
| Parameter | pellet* | powder | | | | |
| L* | 89.6 | 92.9 | 95.1 | 92 | 57.5 | 88.9 |
| a* | −0.4 | −0.3 | −0.2 | −1.4 | 14.7 | −2.3 |
| b* | 4.4 | 4.6 | 4.4 | 6.4 | 10.8 | 6.2 |
| (DL² + Da² + | 6.9 | 4.2 | 2.7 | 6.2 | 42.3 | 8.3 |
| Db²)^{0.5} | | | | | | |

*sample was generated from compression plaque

From Table 4, it can be seen that the coloration highly decreased in the inventive examples (IE1, IE2) are significantly less colored when compared to recycled polypropylene samples and CE3A and on a similar level as CE2 and CE5, where all but white and natural, respectively, have been sorted out.

TABLE 5
Properties of the comparative and inventive examples.

| | | | IE2 | CE1 | CE2 | CE3A | CE3B | |
|---|---|---|---|---|---|---|---|---|
| | | | SBR - | PP flex | PP | PP rigid | PP rigid | CE4 |
| | IE1 | | based | (light | rigid | (mixed | (mixed | Virgin |
| Material/ | SBR - based PP | | PP | color) | (white) | color) | color) | PP |
| Parameter | powder | pellets | | | | | | |
| EEE (wt % | 2.2* | n.m. | 2.3 | 5.9 | 4.6 | 7.5 | 4.9 | 6.2 |
| NMR) | | | | | | | | |
| PPP (wt % | 91.0* | n.m. | 90.1 | 88.8 | 88.4 | 85.7 | 87.1 | 81.3 |
| NMR) | | | | | | | | |
| PEP (wt % | 1.3* | n.m. | 1.3 | 0.8 | 1.3 | 1.2 | 1.4 | 2.1 |
| NMR) | | | | | | | | |
| PEP/EEE | 0.56* | n.m. | 0.55 | 0.13 | 0.29 | 0.16 | 0.28 | 0.35 |
| EPR (wt %, | 7.1* | 7.1 | 8.7 | 5.5 | 8.4 | 7.4 | 9.6 | 15.9 |
| CFC) | | | | | | | | |
| Mw(SF) | 138* | 130 | 132 | 109 | 130 | 147 | 170 | 192 |
| (kg/mol) | | | | | | | | |
| Mw(PE) | 59* | 54 | 42 | 85 | 137 | 102 | 148 | 115 |
| (kg/mol, | | | | | | | | |
| 50-95° C.) | | | | | | | | |
| Mw(SF)/ | 2.3* | 2.4 | 3.1 | 1.3 | 1.0 | 1.4 | 1.1 | 1.7 |
| Mw(PE) | | | | | | | | |
| SCB/1000TC | 304* | 301 | 317 | 212 | 271 | 207 | 230 | 175 |
| CFC (70- | | | | | | | | |
| 95° C.) | | | | | | | | |
| C2 (wt %) | 8.5* | 9.7 | 4.9 | 36.4 | 18.7 | 37.9 | 31.1 | 47.5 |
| CFC (70- | | | | | | | | |
| 95° C.) | | | | | | | | |

*measured on powder sample prior to melt-processing (i.e., extrusion)

From Table 5, can be seen the general properties of the inventive examples (IE1, IE2) when compared to other recycled polypropylene samples (i.e., CE1 to CE3A) and virgin polypropylene (CE4).

TABLE 6
Optical and mechanical properties of the comparative and inventive examples.

| | IE2 | CE3B | CE4 | CE6 | CE7 | CE5 |
|---|---|---|---|---|---|---|
| | SBR - | PP rigid | Virgin | Virgin | Virgin | PP |
| | based | (mixed | heco | random | random | (natural |
| Material/ | PP | color) | PP | PP | PP | color) |
| Parameter | pellets | | | | | |
| MFR₂ (g/10 min, | 35 | 25 | 13 | 8 | 8 | 12 |
| 230° C./2.16 kg) | | | | | | |
| Tensile Modulus (MPa) | 1617 | 1714 | 1382 | 1368 | 1320 | 1654 |
| Charpy Notched Impact | 3.63 | 5.59 | 8.33 | 3.19 | 3.51 | 4.6 |
| Strength (kJ/m²) | | | | | | |
| Haze | 100 | n.m. | 100 | 82 | 87 | 100 |
| Total luminous | 75.5 | n.m. | 71.8 | 88.3 | 89.5 | 72.1 |
| transmittance | | | | | | |
| OMA | 59 | 19 | 115 | 53 | 53 | 76 |
| pOMA | 64 | 20 | 117 | 55 | 54 | 78 |

As can be seen from the data in Table 6, the optics of the present invention (IE2) has similar values as the virgin polymers of similar composition (CE4) in comparison to other recyclate materials of similar composition (CE3B) whereas it is similar to CE5 that requires all but natural color to be sorted out. Despite high haze, surprisingly high total luminous transmittance can be obtained for IE2.

TABLE 7
Further mechanical properties of the comparative and inventive examples.

| | | | CE3A | CE3B | | |
|---|---|---|---|---|---|---|
| | IE1 | IE2 | PP | PP | CE4 | CE5 |
| | SBR | SBR - | rigid | rigid | Virgin | PP |
| | based | based | (mixed | (mixed | heco | (natural |
| Material/ | PP | PP | color) | color) | PP | color) |
| Parameter | pellets | | | | | |
| MFR₂ (g/10 min, | n.m. | 35 | n.m. | 25 | 13 | 12 |
| 230° C./2.16 kg) | | | | | | |
| Tensile Modulus, E | 1580 | 1617 | 1606 | 1714 | 1382 | 1654 |
| (ISO 527-2/1A, MPa) | | | | | | |
| Tensile Strength at | 31.6 | 30.1 | 25.3 | 24.9 | 25.6 | 28.7 |
| yield, TSY (MPa) | | | | | | |
| Elongation at yield, | 6.25 | 5.24 | 3.44 | 3.17 | 4.61 | 4.46 |
| EAY, (%) | | | | | | |
| Flexibility | 13 | 11 | 8 | 7 | 13 | 9 |

As can be seen from the data in Table 7 the flexibility parameter indicates an improvement of the mechanical properties of the SbR materials IE1 and IE2 in comparison to their mechanically-recycled references CE3A and CE3B, respectively (by 57-62% increase). This parameter is similar to what can be obtained by a virgin heterophasic PP reference CE4; which would indicate that this material is virgin-like in this respect.

TABLE 8
Dynamic mechanical properties of the comparative and inventive examples.

| | IE2 | CE3B | CE4 | CE7 |
|---|---|---|---|---|
| | pellets | | | |
| | | PP rigid | Virgin | Virgin |
| | SBR- | (mixed | heco | random |
| Material/Parameter | based PP | color) | PP | PP |
| E' (90° C.) (MPa) | 493.5 | 463.6 | 532.4 | 345.4 |
| E' (120° C.) (MPa) | 256.4 | 203.5 | 272.4 | 128.3 |
| T(E' = 400 MPa) (° C.) | 100.3 | 96.2 | 103.8 | 83.9 |
| T_{g} (PP Matrix) (° C.) | 2.9 | 3.6 | 3.8 | −0.3 |

As can be seen from the data in Table 8, the composition provided by the present invention (IE2) has similar values of E′ (120° C.) and T (E′=400 MPa), suggesting similar dimensional stability at elevated temperature, as the virgin polymers (CE4) in comparison to other recyclate materials (CE3B).

Pellets of IE1, IE2 and CE8 were analyzed by WAXS to determine the degree of crystallinity (Xc) as well as the content of β- and γ-phases of the crystalline structure (remaining phase being α-phase).

Melting temperature (Tₘ) and crystallization temperature (T_{c}) of the samples were determined by DSC (10 K/min).

TABLE 9
WAXS data of comparative and inventive examples.

| | IE1 | IE2 | CE8 |
|---|---|---|---|
| Material/ | SBR- | SBR- | PP |
| Parameter | based PP | based PP | natural |
| | pellets | | |
| X_{C} | 69.4 ± 0.3% | 70.1 ± 0.3% | 67.4 ± 0.1% |
| Kβ | 0.020 ± 0.001 | 0.010 ± 0.001 | 0.010 ± 0.001 |
| Kγ | 0.070 ± 0.002 | 0.090 ± 0.001 | 0.260 ± 0.004 |
| T_{M} [° C.] | 161.5 | 161.9 | 158.4 |
| T_{C} [° C.] | 121.0 | 121.2 | 120.8 |

As can be seen in Table 9, each of samples IE1 and IE2 contains significantly less gamma phase (Kγ) than the mechanically comparative sample CE8.

Sample CE8 was determined to have an ash content of 0.07 wt % (ISO 3451-1), MFR of 14 g/10 min (at 230° C./2.16 kg), C2 content of 4.2 wt % (Crystex), and C2(CF) content of 3.9 wt % (Crystex).

1. A process of preparing a polymer composition comprising a post-consumer recycled polypropylene resin comprising the steps of
M) pre-treating a plastic feedstock by subjecting the plastic feedstock to mechanical recycling process, comprising sieving, sorting by at least one of polymer type, polymer article form, and/or color, shredding, and optionally cleaning, e.g. washing, the plastic feedstock to obtain a pre-treated plastic feedstock;
S) subjecting the pre-treated plastic feedstock to solvent-based recycling process to obtain the post-consumer recycled polypropylene resin accomplished by dissolving a plastic feedstock comprising polypropylene in a solvent and separating non-dissolved components and soluble impurities, wherein step S) comprises
S-a) a dissolution step in which the pre-treated plastic feedstock is placed in contact with a dissolution solvent at a dissolution temperature of between 100° C. and 300° C. and a dissolution pressure of between 1.0 and 20.0 MPa abs, to obtain at least one, crude polymer solution, wherein the dissolution solvent is chosen from organic solvents comprising one or more hydrocarbons with a boiling point of between 75° C. and 250° C., to obtain at least one crude polymer solution;
S-b) optionally a step of adsorption by placing the crude polymer solution obtained from step S-a) in contact with at least one adsorbent, at a temperature of between 10° and 300° C. and a pressure of between 1.0 and 20.0 MPa abs, to obtain at least one refined polymer solution; and
S-c) a step of recovering polymers to obtain at least one solvent fraction and one purified polymer fraction; and
C) melt-processing the post-consumer recycled polypropylene resin obtained from
step S), wherein step C) comprises
C-a) further separating solvent from the purified polymer fraction, and
C-b) melt-processing the purified polymer fraction
to obtain said polymer composition.

2. The process as claimed in claim 1, wherein the process comprises the steps of:
M-a) providing a plastic feedstock, comprising, plastic waste, such as post-consumer waste, comprising polypropylene;
M-b) sieving the plastic feedstock to create sieved plastic waste material comprising polypropylene having only articles with a longest dimension in a defined range, such as from 30 to 400 mm;
M-c) sorting the sieved plastic waste material by means of one or more sorting systems, wherein the sieved waste polymer material is at least sorted by polymer type and/or by color, thereby generating sorted polypropylene recycling material that is subjected to steps M-d) and beyond;
M-d) shredding the sorted polypropylene recycling material to form a flaked polypropylene recycling stream, whereby the flakes have a longest dimension from 2.5 to 20 mm to obtain a pre-treated plastic feedstock;
S-a) a dissolution step involving placing the pre-treated plastic feedstock in contact with a solvent to obtain at least one crude polymer solution; and then
S-E1) optionally a step of separating out the insoluble matter to obtain at least one clarified polymer solution and one insoluble fraction;
S-b) a step of adsorption of the impurities by contact with an adsorbent solid to obtain at least one refined polymer solution;
S-c) a step of recovering polymers, to obtain at least one solvent fraction and one purified polymer fraction;
C-a) further separating solvent from the purified polymer fraction;
C-b) melt-processing, the purified polymer fraction, to obtain a melt-processed, polymer composition comprising the post-consumer polypropylene recycled resin.

3. The process according to claim 1, comprising
M-e) cleaning the pre-treated flaked polypropylene recycling material one or more times with a gaseous and/or aqueous cleaning medium, whereby gravitational principles are applied to separate the flakes from the medium to obtain cleaned pre-treated polypropylene recycling material.

4. The process according to claim 1, comprising
M-f) separating the cleaned pre-treated polypropylene recycling material into a light fraction and a heavy fraction polypropylene recycling material to obtain pre-treated heavy fraction polypropylene recycling material.

5. The process according to claim 1, comprising
M-g) further sorting the pre-treated heavy fraction polypropylene recycling material or, in the case that step M-f) is absent, the cleaned pre-purified polypropylene recycling material by means of one or more optical sorters comprising NIR and/or optical sensors sorting for one or more target polypropylene by removing any flakes containing material other than the one or more target polypropylene(s) and/or of flakes of undesired color (e.g. natural, black etc.), yielding further purified pre-treated polypropylene recycling material.

6. The process according to claim 1, comprising
melt-feeding the pre-treated plastic feedstock to the dissolution step S-a) as a melt feed.

7. The process according to claim 1, wherein
the dissolution solvent in step S-a) is chosen from organic solvents, one or more hydrocarbons with a boiling point of between 8° and 220° C.

8. The process according to claim 1, wherein
in the dissolution step S-a), the dissolution temperature is between 15° and 250° C., and/or the dissolution pressure is between 1.5 and 15.0 MPa abs and/or the dissolution pressure is between 1.5 and 2.4 MPa abs.

9. The process according to claim 1, wherein the mechanical recycling pre-treatment M) includes at least partially melting the pre-treated plastic feedstock before subjecting to the solvent-based recycling process S).

10. The process according to claim 1, wherein step C-a) includes
further separating solvent from the purified polymer fraction, to obtain a solvent content of less than 2,000 ppm of the total weight of the purified polymer fraction.

11. The process according to claim 1, wherein
the plastic feedstock comprises up to 50 wt % of impurities, of impurities of the total weight of the plastic feedstock.

12. The process according to claim 1, wherein
the plastic feedstock comprises at least 60 wt % of polypropylene, of the total weight of the plastic feedstock.

13. The process according to claim 1, wherein C-a) further separating solvent from the purified polymer fraction is performed during C-b) melt-processing of the purified polymer fraction in an extruder with degassing ports at a temperature within the range of from 220 to 280° C. and at a pressure at the degassing ports within the range of from 0.5 kPa to 0.1 MPa abs.

14. The process according to claim 1, wherein step S-c) comprises recovering polymers in at least one solvent recovery section, by evaporation and/or flash devolatization at a temperature within the range of from 100 to 300° C. and at a pressure within the range of from 10 Pa to 4 MPa abs.

15. The process according to claim 1, wherein the polymer composition comprises at least 95 wt %, based on the total weight of the polymer composition, of a post-consumer recycled polypropylene resin.
